(19) United States
(12) Patent Application Publication
(10) Pub. No.: US 2015/0356583 A1
(43) Pub. Date: Dec. 10, 2015

(54) Distributed GPS-Based Sales Efficiency Management System

(71) Applicant: FRESHSTART SYSTEMS INC., Chicago, IL (US)

(72) Inventors: Raymond J. Sheppard, Ocean Ridge, FL (US); Daniel James Gilmartin, Burlingame, CA (US); George Walter Sconyers, III, Chesterfield, MO (US); John Beck Mow, Plano, TX (US); Robert Ogburn, Coahoma, TX (US)

(73) Assignee: FRESHSTART SYSTEMS INC., Chicago, IL (US)

(21) Appl. No.: 14/815,842

(22) Filed: Jul. 31, 2015

Related U.S. Application Data
(63) Continuation-in-part of application No. PCT/US14/14327, filed on Jan. 31, 2014.
(60) Provisional application No. 61/849,736, filed on Feb. 1, 2013.
(60) Provisional application No. 61/899,376, filed on Nov. 4, 2013.

(51) Int. Cl. G06Q 30/02

(52) U.S. Cl. CPC G06Q 30/0205

(57) ABSTRACT

The present invention relates generally to a system of managing contact information and the economic efficiency of a selling entity's evolving relationship with those contacts and particularly to a distributed system for storing and managing contact information and information relating to the activities undertaken in real-time on behalf of the contact while simultaneously and automatically collecting, computing, disseminating sales efficiency data associated with those contacts and the activities undertaken on behalf of them.

### CROSS-REFERENCE TO RELATED APPLICATIONS

This application is a continuation-in-part of Patent Cooperation Treaty App. No. PCT/US14/14327 filed Feb. 3, 2014 in the United States Receiving Office, which takes benefit of U.S. Prov. App. No. 61/849,736 filed Feb. 1, 2013 and U.S. Prov. App. No. 61/899,376 filed Nov. 4, 2013, all of which are hereby incorporated by reference.

### FIELD OF THE INVENTION

The present invention relates generally to a system of managing contact information and the economic efficiency of a selling entity's evolving relationship with those contacts and particularly to a distributed system for storing and managing contact information and information relating to the activities undertaken and to be undertaken on behalf of the contact while simultaneously and automatically collecting, computing, disseminating sales efficiency data associated with those contacts and the activities undertaken on behalf of them and physical locations where those activities occurred in real time.

### DEFINITIONS

In the following specification the term “electronic transactions” means, without limitation, email, mobile phone calls, VOIP calls, and text messages representing electronic funds transfers, accounts payable, invoicing, accounting records, etc. that are created, or will be created, between parties telephonically or electronically. Similarly, the term “distributed system” means an in network-based system in which the logic that constitutes the system and the storage for data is located remotely from the client device. Similarly, the term “other activities” means, without limitation, meeting, trips, and tasks that are undertaken by one party on behalf of another party at a particular location. Similarly, the term “activities” means, without limitation, electronic transactions and other activities. Similarly, the terms “sales professional” and “sales person” mean an individual selling, promoting, or soliciting any type of good, obligation, or service. Similarly, the term “selling entity” means one or more sales professionals or sales people and allied support and supervisory personnel working together with one or more third parties. Similarly, the term “third party” means a subcontractor, supplier, or vendor affiliated with a sales professional, sales person, or selling entity. Similarly, the term “facility” will be used to connote one or more software applications or programs resident on a one or more computers, client devices, web-servers, client devices, or computers operating individually or in concert to achieve a certain set of operational features. Similarly, the term “revenue” or “revenues” means gross revenue or the total proceeds from a transaction or series of related transactions undertaken by a sales professional or selling entity. Similarly the term “expense” or “expenses” or “miscellaneous expenses” means the one or more payments made in connection with a transaction or series of transactions undertaken by a sales professional or selling entity. Similarly, “net revenue” means the balance of revenue minus expense in connection with a transaction or series of transactions undertaken by a sales professional or selling entity.

### BACKGROUND OF THE INVENTION

Stand-alone contact managers like ACT! ®, Outlook®, and larger customer relationship management (CRM) systems like those offered by SAP® and Salesforce.com® are well known in the CRM market. These systems do an excellent job of organizing a selling entity's relationship with the contacts to whom goods and services are being sold or provided to by providing a unified platform for creating, monitoring, and tracking the selling entity's transactions (such as phone calls, email, meetings, tasks undertaken, and so on) on behalf of the contact. Using such tools, selling entities can know when the next call, meeting, or task on behalf of a particular contact is due or has been obligated and respond accordingly.

Uniformly, however, these systems are incapable of characterizing the economic efficiency of the selling entity's relationship with its customer contacts. For example, salesforce.com may be deployed as a call center, where call agents can make/receive calls to/from customer contacts and the time the call agent spends interacting with the customer contact is recorded and tabulated. The system itself emits data regarding the time the call took, the numbers of calls handled in a unit of time, the amount of time spent on a particular type of call, and so on, but this information is devoid of economic data. Simply put, expense information must be supplied after the fact in a separate analysis step and the call data correlated against it to determine economic efficiency data like expense per unit time, expense per call made/received, and so on and whether the efficiency curve for a particular call agent or group of call agents is trending in the proper direction. This mode of operation is appropriate in large organizations where cost accounting and process efficiency systems are widely deployed and closely monitored to ensure profitability. Such data would also be important in solo or small group selling entities such as real estate sales offices but presently available stand-alone systems do not provide it.

Further, existing stand-alone systems are incapable of capturing the necessary metrics to accomplish meaningful economic efficiency analysis. For example, a typical stand-alone CRM system records when a call or trip was scheduled, but cannot automatically record whether the call or trip was completed and, if so, how long the selling entity interacted with the contact. Without this information it is impossible to characterize the temporal efficiency of the selling entity's efforts while in the field and the time in the client's office, as well as the time spent traveling in a vehicle. The user will often multi-task and track the time spent or call other contacts during drive time. Similarly, existing stand-alone systems have no way of capturing the revenue and expense associated with a series of activities on behalf of a contact and thus calculating the time-wise or per activity economic efficiency of the selling entity's sales efforts.

Further complicating the deployment of stand-alone systems offering this kind of functionality is the simple fact that today's sales professionals use a variety of client devices for different purposes. For example, sales professionals make extensive, indeed almost universal, use of mobile phones for voice and text communications with clients. By the same token, sales professionals uniformly use laptop computers or tablet computers almost exclusively for contact management, sales program development, and email, among other things. Thus, a system that calculates the time-wise economic efficiency of the selling entity's sales efforts on behalf of a contact must integrate data from a variety of client devices that are physically disconnected from one another. For example, the length of a phone call is often measured by the mobile phone. If the contact management system is on the user's laptop computer, some means of collecting call detail records from the mobile phone and transferring them to the contact management system must be provided. Similarly, if a call is scheduled to a contact at a particular time, some means of causing the user's laptop-based contact management system to remotely initiate, or prompt for the initiation of, a phone call via the user's mobile phone must be provided. Of course, phone calls may be made via an API (Google Voice, etc.) on the cellular telephone or laptop itself, so the length of a phone call may be recorded directly in the API. By the same token, the geographical location of the parties as they interact with one another is untracked, as stand-alone systems do not include a GPS receiver and simply cannot collect geographical location data.

Finally, after the economic efficiency of the selling entity's efforts in such distributed systems are understood, providing some kind of stimulus such as remediation or a reward may be appropriate. Presently deployed large systems do not offer this functionality. Once again, given the large organizations in which large CRM systems are deployed, this is not surprising. With potentially multiple layers of managerial oversight insinuated hierarchically above the call agent, remediation and reward are usually a face-to-face personnel matters featuring remediation in the form of motivation, training, warnings, discipline, or economic disincentives; or, rewards such praise or economic incentives. Such “carrot and stick” remediation and reward would be equally important in solo or small group selling environments, but presently available stand-alone systems do not provide it.

As an example, consider a solo real estate sales professional. Such an individual ordinarily makes use of a mobile phone for voice and text communications with clients and a laptop computer for contact management, sales program development, and email. In this example, there is no way to assess the economic efficiency of the sales professional's interpersonal communication skills and marketing efforts because the instrumentalities used to effectuate the sales professional's selling efforts (the mobile phone and the laptop) do not communicate with one another. For example, there is no way for the laptop computer—where the sales professional stores contact information and creates and manages sales programs—to know how long the sales professional spent on the phone on behalf of a particular contact or sales program. Thus no analytic system can truly assess the efficiency of the sales professional's efforts. To illustrate further, the sales professional may use his or her laptop computer to create a sales program featuring signage soliciting phone calls to a particular number, which is routed to the sales professional's mobile phone. Presently, there is no way for an analytic system to capture the number of times and the amount of time spent answering calls directed to the number, and thus no way of assessing the efficiency of the sales program (the strength of the call to action, the placement of the signage, the sales professional's interpersonal and selling skills, and so on). As a result, since no assessment the efficiency of the sales professional's efforts is made, the need stimulus such as the aforementioned remediation or reward cannot be determined and thus no such stimulus can be provided.

Thus, it is a first goal of the present invention to improve upon the prior art by providing a distributed GPS-based sales efficiency management system that is capable of characterizing the economic efficiency of the selling entity's sales efforts on behalf of a particular sales contact. Such a system will be able to characterize the selling entity's sales efficiency in terms of, among other things: 1) Revenue, expense, and net revenue associated per unit time and/or per unit electronic transaction (an email, a phone call, a text message, and so on) with the contact; 2) Revenue, expense, and net revenue associated per unit time and/or per unit other activity (a meeting, trip, or task) undertaken with, or on behalf of, the contact; and, 3) Revenue, expense, and net revenue associated per unit time or per unit time and distance of a meeting, trip or a delivery task as measured electronically by a GPS-based computer device.

It is a second goal of the present invention to provide a distributed GPS-based sales efficiency management system that automatically captures and records the number of, and time associated with, with a series of activities such as electronic transactions and/or other activities undertaken with or on behalf of the contact. Activities may include a marketing campaign type in order to know the sales efficiencies for numerous marketing campaigns such as direct mail, pay per click, open house events, or client referrals.

It is a third goal of the present invention to provide a distributed GPS-based sales efficiency management system that captures and records at least the revenue and expense associated with a series of activities such as electronic transactions and/or other activities undertaken with or on behalf of the contact.

It is a fourth goal of the present invention to provide a distributed GPS-based sales efficiency management system that captures and records the number of, and time associated with, a series of activities such as electronic transactions or other activities undertaken with or on behalf of the contact when such electronic transactions or other activities are initiated or undertaken using devices that are physically disconnected from one another.

It is a fifth goal of the present invention to provide a distributed GPS-based sales efficiency management system that automatically calculates the economic efficiency associated with a series of activities such as electronic transactions and/or other activities undertaken with or on behalf of the contact on a per electronic transaction/other activity and/or temporal basis.

It is a sixth goal of the present invention to provide a distributed GPS-based sales efficiency management system that automatically provides a stimulus such as a reward or remediation to the sales professional based on the sales professional's calculated per electronic transaction/other activity and/or temporal sales efficiency.

### BRIEF DESCRIPTION OF THE INVENTION

The distributed GPS-based sales efficiency management system of the present invention is comprised generally of a: 1) A contact management facility for: a) Capturing, storing, and providing access to, identifying, characterizing, and activity related information pertaining to a particular contact; and, b) Capturing, storing, and providing access to revenue (second information) and expenses (third information) pertaining to a particular contact; 2) At least one activity tracker capable of automatically collecting the time spent (first information), the number and geographical location of, and electronic transaction/other activity related information (such as voice recordings of phone calls, email text and attachments, and so on, if any) regarding: a) Electronic transactions (such as voice, email, and text communications); and, b) Other activities such as meetings, trips, and tasks undertaken on behalf of, in conjunction with, directed by, or otherwise associated with, a particular contact; 3) An efficiency analysis facility providing a means of calculating the economic efficiency of the sales professional's efforts on behalf of a contact by calculating one or more economic efficiency ratios comparing revenue (second information), expense (third information), or net revenue (second information minus third information) associated with a particular contact with: a) The time spent (first information) by the sales professional on behalf of a contact; and/or, b) The number of one or more particular kinds of electronic transactions or other activities undertaken on behalf of a contact, to determine revenue, expense, or net revenue per unit of time and/or electronic transaction/other activity expended on a contact; and, 4) A stimulus generator capable of supplying or scheduling a stimulus such as a reward or remediation to the sales professional depending on the economic efficiency ratios calculated above.

While it is conceivable that all these functions will be performed by a unitary hardware system, such as a laptop computer, it is unlikely that they will in a large fraction of cases. The reason is simple: Most solo (and many organized groups of) sales professionals use different devices to do different functions. Mobile phones are used to provide voice and text communications with contacts and thus the functionality of an activity tracker monitoring voice and text communication must reside on the user's mobile phone. Alternately, an API resident in the sales professional's laptop computer provides voice and text communications with contacts. In this instance, the functionality of the activity tracker resides in the user's laptop computer. Similarly, the sales professional's mobile phone (or laptop computer) is usually also used to provide GPS information regarding the geographical location of the sales professional so at least some of the functionality of an activity tracker monitoring the sales professional's location must also reside on the mobile phone (or laptop computer). Laptop computers, on the other hand, are almost universally used to handle other types of communication such as emails and thus at least some of the functionality of an automatic activity tracker monitoring email must reside on the laptop computer.

The contact management facility stores, and allows access to, identifying, characterizing, activity related information pertaining to a particular contact, such as physical and email addresses, phone numbers, and so on. The contact management facility stores this information in a contact database. Like other contact management facilities, the system allows the user to create records memorializing various activities undertaken or to be undertaken on behalf of a contact. For example, a sales professional can create an activity record associated with the contact reminding the sales professional to call or email the contact, have a meeting with the contact, travel somewhere on behalf of the contact, or complete a task on behalf of the contact.

Unlike other contact management facilities, the present invention allows a user to store, and allows access to, actual and prospective economic information and metrics pertaining to a particular contact, such as the expense (third information) associated with servicing the contact and the revenue (second information) derived therefrom. For example, the sales professional may provide services creating a marketing program to sell, for example, a piece of real estate, including printing signs or brochures, buying print or electronic media advertising, and so on. Similarly, the same sales professional may travel on behalf of the contact. Such travel incurs mileage expenses and other travel expenses. Each step undertaken by the sales professional has an expense associated with it and the present invention allows the user to record those expenses in the contact database associated with the contact. Similarly, sales professionals sell products and provide services with the expectation that revenue (and net revenue) will be forthcoming. Accordingly, when revenue is received and/or predicted, the present invention allows a user to record or automatically capture the amount of the revenue in the contact database associated with the contact. Similarly, as expenses are accrued and/or predicted they too are recorded or automatically captured in the contact database associated with the contact.

Also unlike other contact management facilities, the present invention contains at least one activity tracker capable of automatically capturing the time spent (first information), the number of and geographical distance associated with, and any electronic transaction/other activity related information (such as voice recordings of phone calls, email text and attachments, and so on) associated with the various activities undertaken on behalf of, or in conjunction with, the contact. For example, if a scheduled (or impromptu) phone call is made to, or received from, a particular contact, the activity tracker makes a record of the date, and time of the call and the length of time the sales professional talked with the contact. When each task is completed, the activity tracker causes this information to be stored in the contact database associated with the contact. Optionally, the activity tracker may record the conversation and also store it in the contact database. Similarly, a second (or third) activity tracker may record the amount of time associated with (first information), number of, and distances traveled related to other activities such as trips undertaken on behalf of a particular contact by capturing location information from a laptop computer or phone-based GPS receiver by correlating some combination of the user's office and a contact-related addresses as a starting and/or ending point.

The present invention also comprises a means of calculating the economic efficiency of the sales professional's efforts on behalf of the contact by calculating one or more ratios comparing the revenue (second information), expense (third information), or net revenue (second information minus third information) associated with a particular contact using: 1) The time spent (first information) by the sales professional on behalf of the contact; and/or, 2) The number of electronic transactions or other activities undertaken on behalf of the contact. By this means the present invention may be used to determine revenue, expense, and net revenue per unit time and/or unit electronic transaction/other activity expended on the contact.

For example, assume the user is a real estate sale professional that has been retained to sell a contact's residential property. Assume that the selling agent collects a 3% seller's agent commission at closing. For a $100,000.00 property this would be $3,000.00. Now assume further that the seller's agent undertook the following electronic transactions and other activities and expended the following cash amounts on behalf of the selling contact: 1) Six mobile phone calls totaling 90 minutes; 2) Retain a contract staging service for $225.00 to stage the property for an open house; 3) One three-hour open house with one-hour of prep time; 4) $200.00 for layout and print production of box flyers; 5) One hour total for three drive-bys to inspect the property and replenish box signs; 6) Two hours of market research to identify market comparables using Zillow®; and, 7) $100.00 for a sign crew to put down and take up signage. The real estate professional records, or the system automatically captures, the following revenue and expenses in conjunction with this property sale:

TABLE 1

| Revenue/Misc. Expense | Amount |
|---|---|
| Gross Commission | $3,000.00 |
| Staging Service | $225.00 |
| Box Flyer Production | $200.00 |
| Sign Crew | $100.00 |
| Net Revenue | $2,475.00 |

The system automatically records the following electronic transactions (mobile phone calls) and other activities (the open house, drive-bys, and website-based market research) in conjunction with this property sale as follows:

TABLE 2

| ETs/OAs | Number | Time (hours) |
|---|---|---|
| Mobile Phone Calls | 6 | 1.500 |
| Open House | 1 | 4.000 |
| Drive-bys | 3 | 1.000 |
| Market Research | 1 | 2.000 |
| | 11 | 8.500 |

Using this data, the system automatically calculates that the sales professional has generated net revenues of $2,475.00 after deducting miscellaneous expense items totaling $525.00 from the $3,000.00 seller's agent gross commission (revenue) paid at closing. The system further calculates that the sales professional has generated this $2,475.00 in conjunction with 8.5 hours of his or her effort: 1.5 hours of electronic transactions (mobile phone calls) and 7.0 hours of other activities (the open house, drive-bys, and web-site based market research). Thus, one measure of the sales professional's economic efficiency is the $2,475.00 of net revenues divided by 8.5 hours or $291.18 per hour of effort. Similarly, another measure of the sales professional's economic efficiency is the $2,475.00 of net revenues divided by 11 electronic transactions/other activities or $225.00 per electronic transaction/other activity. Since the system automatically generates these ratios in real-time, the sales professional can know instantly his or her real-time economic efficiency on behalf of contact. Also, management can compare these real-time ratios to the sales professional's historic sales efficiency to determine any upward or downward trends. Similarly, these ratios can be compared to the sales efficiencies of other sales professionals to determine a relative ranking of this sales professional versus the others.

As another example, assume the user is a mutual fund sales professional dealing in mutual funds with a 5% front-end load, or sales charge. Assume that the sales professional retains 100% of the sales charge. For a $10,000.00 investment this would be $500.00. Now assume further that the sales professional interacts with his or her clients exclusively via mobile phone. In this example, assume that the sales professional originated/accepted three mobile phone calls of 15 minutes each (45 minutes or 0.75 hours total) with the client before placing the client's order with a brokerage house. Since the selling agent has incurred no miscellaneous expenses, the entire $500.00 commission is carried forward as net revenue. As before, one measure of the sales professional's economic efficiency is the $500.00 of net revenue divided by 0.75 hours or $666.67 per hour of effort. As before, the system also calculates the sales professional's economic efficiency per electronic transaction (mobile phone call) originated to, or taken from, the contact. Here, the system would divide the $500.00 of net revenues by 3 to determine that the sales professional generated net revenues of $166.67 for every mobile phone call originated or taken on behalf of this client. As before, since the system automatically generates these ratios in real-time, the sales professional can instantly know his or her real-time economic efficiency on behalf of contact. For example, if the sales professional placed the order after only two mobile phone calls, the system would divide the $500.00 of net revenue divided by 0.50 hours to determine that the sales professional had generated $1,000.00 per hour of effort. Similarly, the system would also calculate the sales professional's economic efficiency per electronic transaction by dividing the $500.00 of net revenues by 2 to determine that the sales professional generated net revenues of $250.00 for every mobile phone call originated or taken on behalf of this client. Also as before, these ratios can be compared to the sales efficiencies of other sales professionals to determine a relative ranking of this sales professional versus the others. One such scenario would involve the system or a sales manager affiliated with the selling entity comparing these ratios with a number of the sales professional's peers over a fixed period of time and declaring, for example, the top three most efficient sales professionals to be winners of a contest.

As another example, assume the user is an attorney counseling individual estate and tax-planning needs under the terms of a $5,000.00 annual pre-paid, non-refundable retainer agreement. Now assume further that the attorney interacts with his or her clients exclusively via telephone and face-to-face, off-site meetings. In this example, assume that the attorney originated/accepted 10 mobile phone calls totaling 5 hours during the year and met with the client 5 times during the year for 5 hours expending a total of 50 miles of GPS trackable distance for the meetings. Since the attorney has incurred no miscellaneous expenses in this example, the entire $5,000.00 pre-paid annual retainer commission is carried forward as net revenues. As before, one measure of the attorney's economic efficiency is the $5,000.00 of net revenues divided by 10 hours or $500.00 per hour of effort. In this case however, the system also calculates the attorney's economic efficiency per electronic transaction (mobile phone call) originated to, or taken from, the client. Here, the system would divide the $5,000.00 of net revenues by 10 to determine that the attorney generated net revenues of $500.00 for every mobile phone call originated or taken on behalf of this client. Similarly, the system also calculates the attorney's economic efficiency per trip to attend face-to-face, off-site meetings with the client. Here, the system would divide the $5,000.00 of net revenue by 5 to determine that the attorney generated net revenues of $1,000.00 for every meeting with this client. Similarly, the system also calculates the attorney's economic efficiency per unit distance traveled to attend face-to-face, off-site meetings with the client. Here, the system would divide the $5,000.00 of net revenue by 50 miles to determine that the attorney generated net revenues of $100.00 for every mile traveled meeting with this client. As before, any one or more, of these measurements of economic efficiency can be generated in real-time and compared to the attorney's historic economic efficiency over time to determine upward or downward trends and these can be compared to the economic efficiencies of other attorneys to determine a relative ranking of this attorney versus the others. Also as before, any one or more, of these measurements of economic efficiency can be generated using recorded or prospective economic information to determine a relative ranking of this attorney versus the others.

Calculating sales efficiencies as described above and using them to compare an individual's economic efficiency with various benchmarks makes it possible to determine if some kind of stimulus, such as a reward for superior performance, or, remediation for inferior effort, is appropriate. For example, a solo sales professional might be rewarded by a series of reinforcing affirmations as his or her sales efficiency holds steady or improves over time. The same sales professional might be remediated by a series of instructive or supportive affirmations if his or her sales efficiency falls over time or fails to improve enough over an extended period of time. The same sales professional may be remediated by means of exposure to online or face-to-face training or instructive programs if sales efficiency stays low. In group selling, or organized institutional sales environments, a reward may take the form of a financial incentive such as a bonus while remediation may take the form of a financial disincentive such as a reduction in expected payout from one or more transactions. Another application concerns comparing a group of similarly situated sales professionals selling similar goods and service over the same period of time and using the economic efficiency ratios thus determined as the basis of a sales efficiency contest. For example, the three most efficient salespeople over a fixed sales period may be awarded decreasing bonus payments for their superior performance versus their peers.

Assuming that a solo real-estate sales professional acting as a seller's agent uses: 1) A laptop computer for contact management, sales program development, voice calling and email; and, 2) A mobile phone for text communications, one embodiment of the present invention may be used in the following manner: First, the sales professional creates an entry in the contact database containing identifying and characterizing data relating to the selling contact. For example, the sales professional might record the contact's name, home phone number, mobile phone number, email address, mailing address, and the contact's listed property address, asking price, price per square foot, negotiated commission split, expected commission amount, and so on. Next, the sales professional associates a unique phone number with the selling contact's listed property and lists the property on a listing service such as the Multiple Listing Service® with the unique phone number featured in the listing. Next, potential buyers call the designated number and the call terminates as usual on the sales professional's laptop computer. The parties talk, and as they converse, an activity tracker operating on the sales professional's laptop computer records the buyer's phone number, the time the call was received, and the elapsed time of the call. The activity tracker may also record the conversation between the parties as it occurs. Next, sometime after the conversation has been concluded, the activity tracker transfers the phone number called, buyer's phone number, the time the call was received, and the elapsed time of the call to the contact management facility on the sales professional's laptop computer where it is stored and linked to the contact's record in the contact database. If the activity tracker also recorded the conversation between the parties, the digitized recording is also transferred to the contact management facility where it too is stored and linked to the contact's record in the contact database. Over time, the sales professional takes additional calls regarding the contact's listed property from potential buyers and buyer's agents and the activity tracker collects and transfers the details associated with each mobile phone call to the contact management facility where they are stored and linked to the contact's record in the contact database. Eventually the sales professional concludes the sale and at closing, the sales professional is paid his or her agreed split of the commission and enters the actual commission amount into the contact management facility. At this time the system calculates a number of ratios determining the sales professional's economic efficiency. For example, the actual commission amount received may be divided by the number of mobile phone calls made/taken to determine the commission earned per mobile phone call. Similarly, the actual commission amount received may be divided by the total amount of time in minutes or hours making/taking mobile phone calls on behalf of the selling contact to determine the amount of commission earned per minute or hour, respectively. Finally, these calculated sales efficiency ratios may be used to compare the sales professional's selling efficiency with his or her own past performance or the past or current performance of other sales professionals. As before, any one or more, of these measurements of economic efficiency can be generated using recorded or prospective economic information to determine a relative ranking of this sales professional versus the others.

Another embodiment of the present invention functions as above except that the activity tracker collects and transfers the details associated with each mobile phone call to the contact management facility in real-time where the contact management facility calculates the sales professional's economic efficiency ratios in real-time based on the expected commission amount. Some or all of these calculated economic efficiency ratios are instantly relayed back to the activity tracker where they are displayed on the sales professional's mobile phone. This gives the sales professional a real-time overview of his or her economic efficiency on behalf of the selling contact.

### BRIEF DESCRIPTION OF THE DRAWINGS

FIG. 1 is an architectural diagram according to a first embodiment of the present invention.

FIG. 2 is an architectural diagram according to a second alternative embodiment of the present invention.

FIG. 3 is an architectural diagram according to a third alternative embodiment of the present invention.

FIG. 4 is an operational flowchart showing the operation of an email activity tracker according to one embodiment of the present invention.

FIG. 5 is an operational flowchart showing the operation of a mobile phone call activity tracker according to one embodiment of the present invention.

FIG. 6 is an operational flowchart showing the operation of a VOIP call activity tracker according to one embodiment of the present invention.

FIG. 7 is an operational flowchart showing the operation of a text message activity tracker according to one embodiment of the present invention.

FIG. 8 is an operational flowchart showing the operation of a GPS location activity tracker according to one embodiment of the present invention.

FIG. 9 is a non-limiting implementation of user interface screen showing a contact list display according to one embodiment of the present invention.

FIG. 10 is a non-limiting implementation of user interface screen showing an electronic transaction display according to one embodiment of the present invention.

FIG. 11 is a non-limiting implementation of user interface screen showing an other activities display according to one embodiment of the present invention.

FIG. 12 is a non-limiting implementation of user interface screen showing a revenue and expenses display according to one embodiment of the present invention.

FIG. 13 is a non-limiting implementation of user interface screen showing a review efficiency display according to one embodiment of the present invention.

FIG. 14 is a non-limiting implementation of user interface screen showing a review stimulus display according to one embodiment of the present invention.

### DETAILED DESCRIPTION OF THE EMBODIMENTS

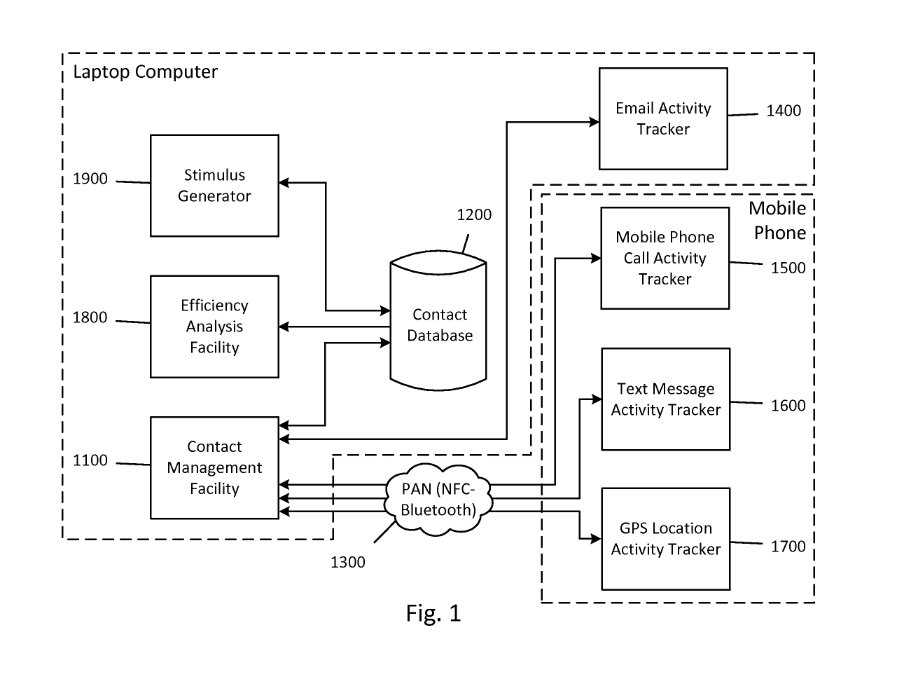

Referring now to FIG. 1, in a first embodiment of the present invention, C++ is the preferred development language for elements residing on laptop computers and the like. Those having skill in the art will recognize there are almost innumerable acceptable alternatives. This embodiment also requires contact database 1200 on the sales professional's laptop computer. For example, on Windows-based laptop computers, Microsoft® Access® or FileMaker® Pro are both acceptable database engine alternatives. Similarly, on Apple® personal computers, FileMaker Pro is widely used. Those having skill in the art will recognize there are numerous acceptable alternatives. Indeed, a large number of SQL database engines are available on both Windows and Apple-based personal computing devices and are readily adaptable by those having skill in the art.

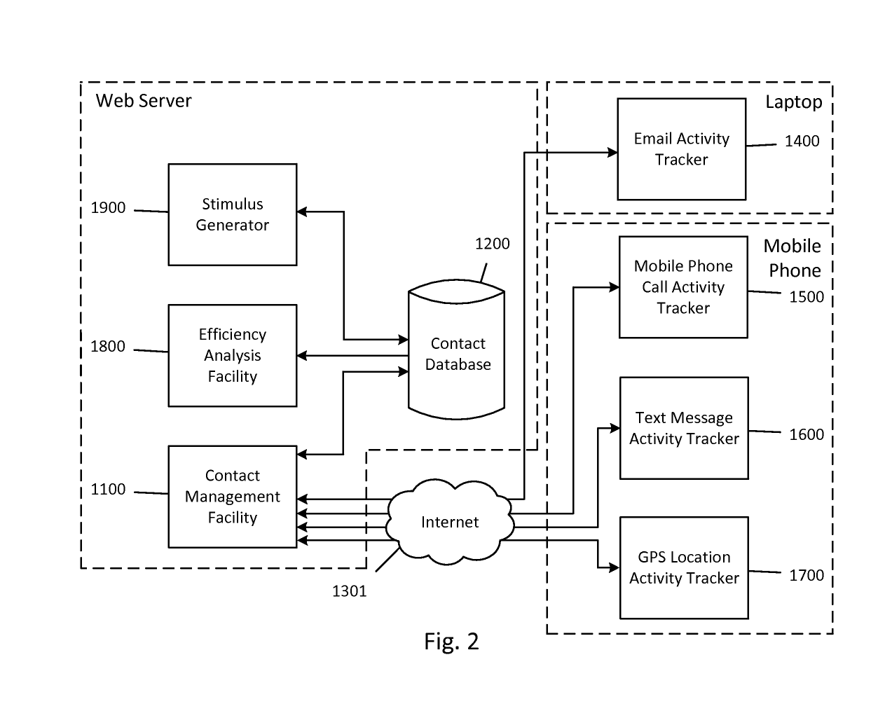

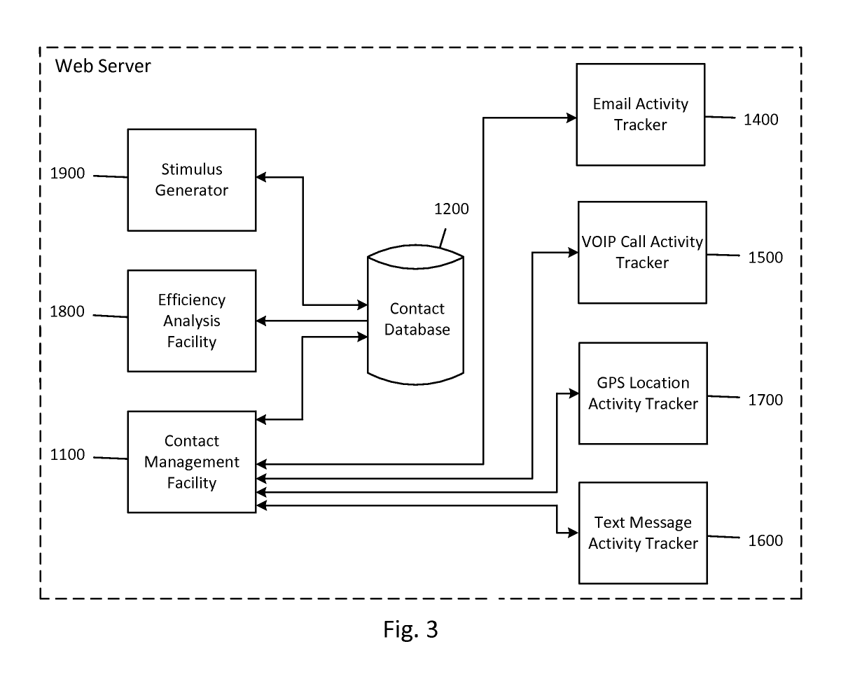

Referring now to FIGS. 2 and 3, in second and third alternative embodiments, respectively, of the present invention, some of the functionality present on the sales professional's laptop computer in the first embodiment is displaced to a web server (i.e. contact management facility 1100, contact database 1200, efficiency analysis facility 1800, and stimulus generator 1900). Other parts of the system may, or may not, be distributed to a web server (i.e. email activity tracker 1400, mobile phone call or VOIP call activity tracker 1500, GPS location activity tracker 1700, and text message activity tracker 1600). Such web-based systems are implemented in various ways all of which are functionally equivalent. For example, in the following description of the second and third alternative embodiments, ASP.NET and C# are the preferred web development and program development languages, respectively. Those having skill in the art will recognize that numerous other equivalent development environments that may be used. For example, PHP is a well-known web development language and compiled system service routines written in C, C++, and even C# may be freely integrated. Thus, it will be readily apparent that such methods of deploying a web-based system are functionally equivalent to the method described and all such methods are included in the spirit and scope of the present invention. Similarly, in the following description of the second and third alternative embodiments, Microsoft SQL is the preferred database engine. Those having skill in the art will recognize that numerous functional equivalents such as MySQL® are commonly available and that all such equivalents are included in the spirit and scope of the present invention. Similarly, in the following description of the first and second alternative embodiments, a Microsoft Windows web server is identified as the preferred web server. Those having skill in the art will recognize that numerous functional equivalents such as Apache® are commonly available and that all such equivalents are included in the spirit and scope of the present invention.

Referring now to FIGS. 1, 2, and 3, in all disclosed embodiments of the present invention at least some of the functionality of the system resides on the sales professional's mobile phone. Such client-based systems are implemented in various ways all of which are functionally equivalent. For example, depending on whether the mobile phone operates on the Android or iOS operating system, Java and Objective-C, respectively, are commonly used development environments. In both cases, C++ libraries are used for more compute intensive procedures. Nevertheless, numerous other development environments are commonly used and well-known to those having skill in the art.

Referring specifically now to FIG. 1, a first embodiment of the present invention is illustrated. This is an exemplary embodiment of a “network-disconnected” variant of the present invention. The system comprises: 1) Contact management facility 1100 for: a) Capturing, storing, and providing access to, identifying, characterizing, and activity related information pertaining to a particular contact; and, b) Capturing, storing, and providing access to revenue (second information) and expense (third information) pertaining to a particular contact; 2) Four activity trackers: a) Email activity tracker 1400; b) Mobile phone call activity tracker 1500; c) Text message activity tracker 1600; and, d) GPS location activity tracker 1700 capable of automatically collecting the time spent (first information), number of, and electronic transaction/other activity related information (if any) regarding: a) Emails; b) Phone calls such as mobile phone calls or VOIP calls; c) Text messages; and, d) Trips and journeys undertaken on behalf of a particular contact, respectively, and then transferring such information to contact management facility 1100 for storage in contact database 1200 associated with the particular contact with whom the electronic transaction or other activity was undertaken; 3) Efficiency analysis facility 1800 providing a means of calculating the economic efficiency of the sales professional's efforts on behalf of a particular contact by calculating one or more economic efficiency ratios comparing revenue (second information), expense (third information), or net revenue (second information minus third information) associated with a particular contact using: a) The time spent (first information) by the sales professional on behalf of a contact; and/or, b) The number of one or more particular kinds of electronic transactions or other activities undertaken on behalf of a contact, to determine revenue, expense, or net revenue per unit of time and/or per electronic transaction/other activity expended on a contact and then transferring such information to contact management facility 1100 for storage in contact database 1200 associated with the particular contact with whom the electronic transaction or other activity was undertaken; and, 4) Stimulus generator 1900 capable of querying contact database 1200 to retrieve the economic efficiency ratios stored therein and supplying or scheduling one or more stimuli such as a reward, remediation, or penalty to the sales professional depending on the retrieved economic efficiency ratios.

In this embodiment, contact management facility 1100, contact database 1200, efficiency analysis facility 1800, and stimulus generator 1900 all reside on the sales professional's laptop computer. Similarly, email activity tracker 1400 also resides on the sales professional's laptop computer. By contrast, mobile phone call activity tracker 1500, text message activity tracker 1600, and GPS location activity tracker 1700 reside on the sales professional's mobile phone. Ordinarily, although not necessarily, contact management facility 1100, efficiency analysis facility 1800, and stimulus generator 1900 present a single set of user interface screens to the sales professional. Ordinarily, but not necessarily, mobile phone call activity tracker 1500, text message activity tracker 1600, and GPS location activity tracker 1700 are implemented as mobile phone based service routines and may be combined to comprise a unitary service routine.

Since, contact management facility 1100, contact database 1200, efficiency analysis facility 1800, stimulus generator 1900, and email activity tracker 1400 all reside on the sales professional's laptop computer, and in fact may be implemented as a unitary application, communication between these elements is facilitated by a broad variety of inter-process or inter-task communication techniques well known in the prior art. By contrast, mobile phone call activity tracker 1500, text message activity tracker 1600, and GPS location activity tracker 1700 reside on the sales professional's mobile phone. In this embodiment of the present invention, necessary communication between contact management facility 1100 and mobile phone call activity tracker 1500, text message activity tracker 1600, and GPS location activity tracker 1700 is effectuated by means of a wireless Personal Area Network (PAN) 1300 such as that facilitated by Bluetooth® or RFID-based Near Field Communication (NFC) transceivers in the laptop and mobile phone. Of course, those having skill in the art will readily recognize that other common wireless (e.g. Wi-Fi) and wired techniques may be used to accomplish the same goal.

Referring now to FIG. 2, a second alternative embodiment of the present invention is disclosed. This is an exemplary embodiment of a “cloud-based” network attached variant of the present invention. As above, the system comprises: 1) Contact management facility 1100; 2) Four activity trackers: a) Email activity tracker 1400; b) Mobile phone call activity tracker 1500; c) Text message activity tracker 1600; and, d) GPS location activity tracker 1700; 3) Efficiency analysis facility 1800; and, 4) Stimulus generator 1900.

The main difference between the second alternative embodiment and the first embodiment of the present invention is that: 1) Contact management facility 1100, contact database 1200, efficiency analysis facility 1800, and stimulus generator 1900 reside on a remote web server accessible via a network such as the Internet 1301 by means of a web browser on the sales professional's laptop computer; 2) Email activity tracker 1400 resides on the laptop computer where the sales professional's email client resides; and, 3) Mobile phone call activity tracker 1500, text message activity tracker 1600, and GPS location activity tracker 1700 reside on the sales professional's mobile phone. Ordinarily, although not necessarily, the remote web server presents remote contact management facility 1100, efficiency analysis facility 1800, and stimulus generator 1900 to the sales professional as a single set of user interface screens. Ordinarily, but not necessarily, email activity tracker 1400 is implemented as a laptop based service routine. Ordinarily, but not necessarily, mobile phone call activity tracker 1500, text message activity tracker 1600, and GPS location activity tracker 1700 are implemented as mobile phone based service routines and may be combined to comprise a unitary service routine. This embodiment of the present invention has the advantage of being equally accessible from different locations by a number of individuals constituting a selling entity including the sales professional and other individuals working with him or her including but not limited to, supervisors, counselors, consultants, subcontractors, and the like.

Since, contact management facility 1100, contact database 1200, efficiency analysis facility 1800, and stimulus generator 1900 all reside on the remote web server, and in fact may be implemented as a unitary web application, communication between these elements is facilitated by a broad variety of inter-process or inter-task communication techniques well known in the prior art. Since email activity tracker 1400 resides on the laptop computer where the sales professional's email client resides, necessary communication between contact management facility 1100 and email activity tracker 1400 is effectuated wirelessly by means of a network such as the Internet 1301. Similarly, mobile phone call activity tracker 1500, text message activity tracker 1600, and GPS location activity tracker 1700 reside on the sales professional's mobile phone. In this this embodiment of the present invention, necessary communication between contact management facility 1100 and mobile phone call activity tracker 1500; c) Text message activity tracker 1600; and, d) GPS location activity tracker 1700 is effectuated wirelessly by means of a network such as the Internet 1301.

Referring now to FIG. 3, a third alternative embodiment of the present invention is disclosed. This is another exemplary embodiment of a “cloud-based” network attached variant of the present invention. As above, the system comprises: 1) Contact management facility 1100; 2) Four activity trackers: a) Email activity tracker 1400; b) VOIP call activity tracker 1500; c) Text message activity tracker 1600; and, d) GPS location activity tracker 1700; 3) Efficiency analysis facility 1800; and, 4) Stimulus generator 1900.

The main difference between the third alternative embodiment and the first embodiment of the present invention is that: 1) Contact management facility 1100, contact database 1200, efficiency analysis facility 1800, and stimulus generator 1900 reside on a remote web server accessible via a network such as the Internet 1301 by means of a web browser on the sales professional's mobile telephone; 2) The sales professional uses a VOIP calling service (like Google® Voice, Skype®, Cisco® Telepresence®, Apple Facetime®, or the like) on his or her mobile telephone in lieu of making/receiving calls via his or her cellular service and to make/receive video calls and video conference sessions; 3) Email activity tracker 1400, requisite VOIP call activity tracker 1500, and GPS location activity tracker 1700 reside on the sales professional's remote web-server where the email client and VOIP calling client, respectively, reside; and, 4) Text message activity tracker 1600 also resides on the sales professional's remote web-server. As above, this embodiment of the present invention has the advantage of being equally accessible from different locations by a number of individuals constituting a selling entity including the sales professional and other individuals working with him or her including but not limited to, supervisors, counselors, consultants, subcontractors, and the like.

Ordinarily, the remote web server presents remote contact management facility 1100, efficiency analysis facility 1800, and stimulus generator 1900 to the sales professional as a single set of user interface screens. Ordinarily, email activity tracker 1400, VOIP call activity tracker 1500, and GPS location activity tracker 1700 are implemented as remote web-server based service routines. Ordinarily, text message activity tracker 1600 is also implemented as remote web-server based service routines and may be combined with the other service routines to comprise a unitary service routine.

Since, contact management facility 1100, contact database 1200, efficiency analysis facility 1800, and stimulus generator 1900 all reside on the remote web server, and in fact may be implemented as a unitary web application, communication between these elements is facilitated by a broad variety of inter-process or inter-task communication techniques well known in the prior art. Since email activity tracker 1400, VOIP call activity tracker 1500, and GPS location activity tracker 1700 reside on the remote web-server where the sales professional's email client, VOIP calling client, and GPS location activity client, respectively, reside, necessary communication between cloud-based contact management facility 1100, email activity tracker 1400, VOIP call activity tracker 1500, and GPS location activity tracker 1700 may be effectuated by means of interprocess communication. Similarly, text message activity tracker 1600 resides on the sales professional's remote web-server. As mentioned before, in this embodiment of the present invention, necessary communication between all these cloud-based contact management tools is effectuated by means of interprocess communication.

Referring now to FIGS. 1, 2, and 3, email activity tracker 1400 determines when an email is sent to, or received from, a particular contact. Email activity tracker may run on the client device or may run in the remote web-server. Email activity tracker 1400 captures and supplies the email address, date, time, text, geographical location, and attachments comprising the email and time spent composing or reading the email, respectively (first information), to contact management facility 1100 for storage in contact database 1200 associated with the contact to whom, or from whom, the email was sent or received, respectively. In the disclosed embodiments, the sales professional creates and receives email using an email client like Microsoft Outlook® in the usual manner. Email activity tracker 1400 may be implemented as a standalone service routine or as an add-on service routine used in conjunction with the email client. For example, “Outlook Add-ons” may be developed using Microsoft Visual C#® or Visual Basic®. Alternately, Microsoft's MAPI mail system API may also be used to create an appropriate service routine interfacing directly to the message API and store. Of course, those having skill in the art will recognize that numerous alternative email clients may be used and that numerous alternative methods of creating service routines capable capturing the date, time, text, and geographical location of each email and the amount of time spent reading or composing email from, or to, a particular contact, respectively are well known in the prior art. While email activity tracker 1400 may run in real time or periodically on a scheduled basis accessing email messages stored by the email user, the preferred embodiment of the present invention requires that email activity tracker 1400 run at all times so that accurate measurements of composition and reading time may be measured and real-time status prompts from contact management facility 1100 may be displayed.

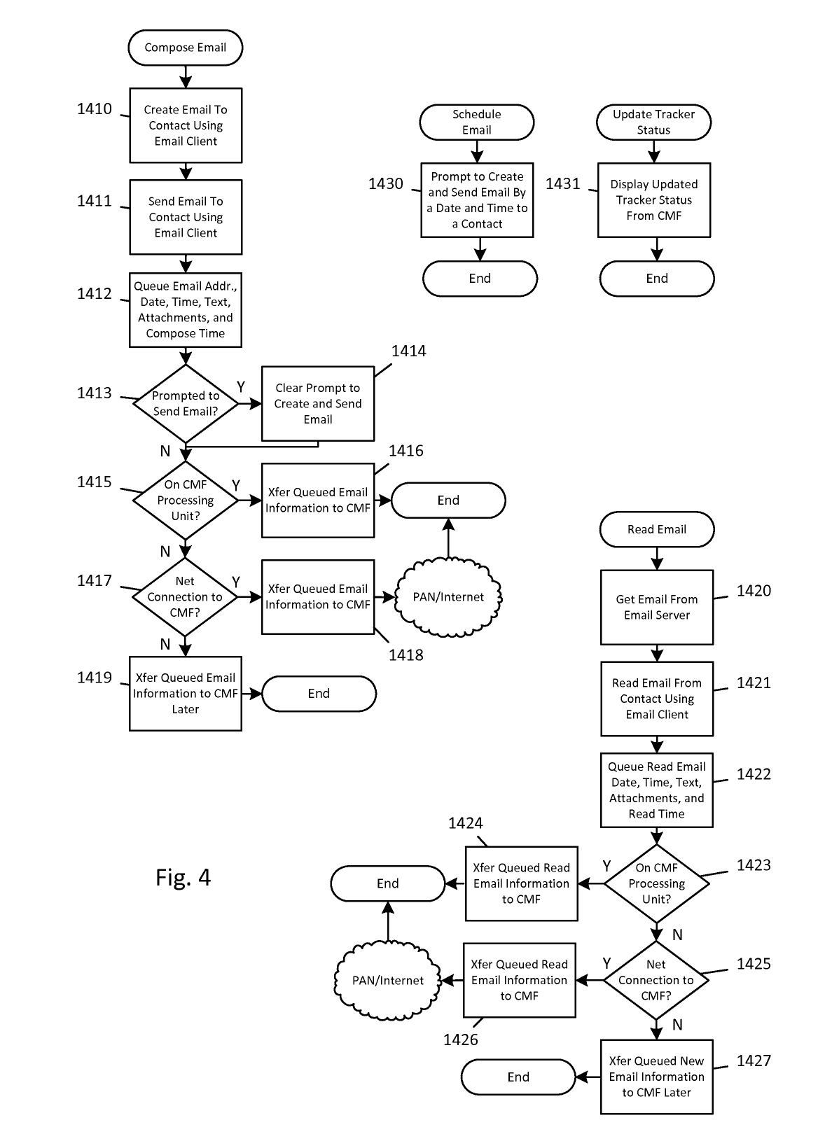

Referring now to FIGS. 1, 2, and 3 and FIG. 4, a process flowchart illustrating the operation of email activity tracker 1400 is provided. To send an email, the sales professional composes an email to a contact using his preferred email client (1410). Next, the sales professional sends the email in the usual way via his email client (1411). Next, when the email is sent, email activity tracker 1400 acquires the email address, date, time, text, geographical location, and attachments comprising the email and the amount of time the sales professional spent composing the email (first information) and queues them for transmission to contact management facility 1100 (1412). Next, email activity tracker 1400 determines if it had been directed to visually prompt the sales professional to compose and send the email (1413). If so, email activity tracker 1400 clears the visual prompt (1414). Next, email activity tracker 1400 determines if it ordinarily executes on the same processing unit as contact management facility (CMF) 1100 (1415). If it does, email activity tracker 1400 transfers any queued email information directly to contact management facility 1100 (1416). If not, email activity tracker 1400 determines if it can create a network connection via PAN network 1300 or the Internet 1301 to contact management facility 1100 (1417). If it can, email activity tracker 1400 transmits any queued email information to contact management facility 1100 (1418). If it cannot, email activity tracker 1400 queues the newly prepared email information for subsequent transmission to contact management facility 1100 when connected to contact management facility 1100 via PAN network 1300 or the Internet 1301 (1419).

When receiving email, the sales professional's preferred email client acquires new email periodically or in real-time from an associated email server (1420). Next, the sales professional reads the email in the usual way via his email client (1421). Next, after the email is read, email activity tracker 1400 acquires the date, time, text, geographical location, and attachments comprising the email and the amount of time the sales professional spent reading the email (first information) and queues them for transmission to contact management facility 1100 (1422). Next, email activity tracker 1400 determines if it ordinarily executes on the same processing unit as contact management facility (CMF) 1100 (1423). If it does, email activity tracker 1400 transfers any queued email information directly to contact management facility 1100 (1424). If not, email activity tracker 1400 determines if it can create a network connection via PAN network 1300 or the Internet 1301 to contact management facility 1100 (1425). If it can, email activity tracker 1400 transmits queued email information to contact management facility 1100 (1426). If it cannot, email activity tracker 1400 queues newly acquired email information for subsequent transmission to contact management facility 1100 when connected to contact management facility 1100 via PAN network 1300 or the Internet 1301 (1427).

Of course, the sales professional may use contact management facility 1100 to schedule that an email message be sent to a particular contact at some future date and time. After queuing the sales professional's desire to send an email at a later date and time, contact management facility 1100 determines if it ordinarily executes on the same processing unit as email activity tracker 1400 (i.e. if email activity tracker 1400 is on the same device as contact management facility 1100). If it does (or is), contact management facility 1100 transfers any queued email scheduling information directly to email activity tracker 1400 and email activity tracker 1400 displays a prompt on the sales professional's local device (1430). If it does not, (i.e. email activity tracker 1400 is on a remote device), contact management facility 1100 determines if it can create a network connection via PAN network 1300 or the Internet 1301 to remote email activity tracker 1400. If it can, contact management facility 1100 transmits queued email scheduling information to remote email activity tracker 1400, remote email tracker 1400 displays a prompt on the remote device (1430). If it cannot, contact management facility 1100 subsequently transmits queued email scheduling information to remote email activity tracker 1400 when connected to remote email activity tracker 1400 via PAN network 1300 or the Internet 1301. Remote email activity tracker 1400 then displays a prompt on the remote device (1430). When the sales professional subsequently composes and sends the scheduled email, the process outlined above in [0056] governing outgoing emails is invoked.

As the sales professional composes or reads email to, or from, a particular contact, respectively, contact management facility 1100 may from time to time provide status updates concerning the sales professional's economic efficiency with respect to that contact or any other contact or group of contacts. If so, email activity tracker 1400 displays these status updates in real-time as they arrive on the sales professional's device (1431).

Finally, in the context of the foregoing discussion it will be readily understood that in lieu of determining if email activity tracker 1400 resides with, is permanently connected to, or is transiently connected to, contact management facility 1100 as discussed above, special purpose versions of email activity tracker 1400 may be created that are specific for each of the three described situations (i.e. residing with contact management facility 1100, permanently connected to contact management facility 1100, or transiently connected to contact management facility 1100).

Referring now to FIGS. 1 and 2 mobile phone call activity tracker 1500 determines when a mobile phone call is made to, or received from, a particular contact. Mobile phone call activity tracker 1500 captures and supplies the phone number, date, time, geographical location, the time spent making or taking the call, respectively (first information), and optionally (based on state legal requirements) an audio recording of the mobile phone call, to contact management facility 1100 for storage in contact database 1200 associated with the contact to whom, or from whom, the mobile phone call was made to or received from. In the disclosed embodiments, the sales professional makes and receives mobile phone calls using a conventional Android or Apple iOS-based mobile phone. Mobile phone activity tracker 1500 is ordinarily implemented as a standalone service routine running independently on the mobile phone or remote web-server. Of course, it will be readily recognized that numerous types of mobile phones with numerous types of operating systems are available and that numerous alternative methods of creating service routines capable of capturing the phone number, date, time, geographical location, the time spent, and optionally an audio recording of the mobile phone call (where legally allowed) are well known in the prior art. While mobile phone call activity tracker 1500 may run in real time or periodically on a scheduled basis accessing call detail records stored on the phone, the preferred embodiment of the present invention requires that mobile phone call activity tracker 1500 run at all times on the remote web-server so that audio recordings of mobile phone calls may be made and real-time status prompts from contact management facility 1100 may be displayed.

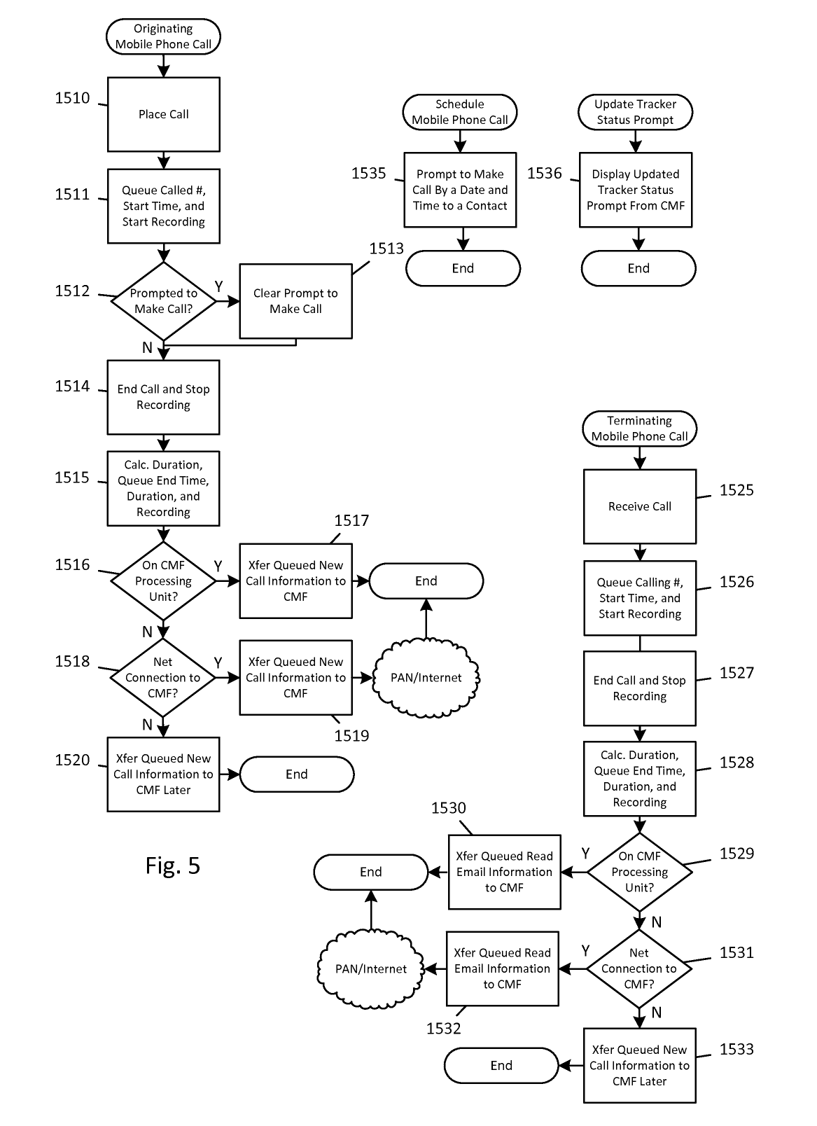

Referring now to FIGS. 1, 2, and FIG. 5, a process flowchart illustrating the operation of mobile phone call activity tracker 1500 is provided. To make a call, the sales professional uses his or her mobile phone to place a call to the contact (1510). Next, mobile phone call activity tracker 1500 collects the called contact's phone number, the originating date and time of the call, the geographical location, and (again based on state legal and user requirements) optionally begins recording the call (1511). Next, mobile phone activity tracker 1500 determines if it had been directed to visually prompt the sales professional to make the call (1512). If so, email activity tracker 1400 clears the visual prompt (1513). Next, the call ends and any optional recording stops (1514). Next, mobile phone call activity tracker 1500 queues the contact's phone number, originating date and time, terminating date and time, calculated difference between the originating date and time and the terminating date and time (first information), and any optional audio recording for transmission to contact management facility 1100 (1515). Next, call activity tracker 1500 determines if it ordinarily executes on the same processing unit as contact management facility (CMF) 1100 (1516). If it does, mobile phone call activity tracker 1500 transfers any queued call information directly to contact management facility 1100 (1517). If not, mobile phone call activity tracker 1500 determines if it can create a network connection via PAN network 1300 or the Internet 1301 to contact management facility 1100 (1518). If it can, mobile phone call activity tracker 1500 transmits any queued call information to contact management facility 1100 (1519). If it cannot, mobile phone call activity tracker 1500 queues newly prepared call information for subsequent transmission to contact management facility 1100 when connected to contact management facility 1100 via PAN network 1300 or the Internet 1301 (1520).

When receiving a mobile phone call, the sales professional answers the call as he or she normally does (1525). Mobile phone call activity tracker 1500 collects the calling contact's phone number, the date and time of the call, the geographical location, and optionally begins recording the call (1526). Next, when the call concludes mobile phone call activity tracker 1500 collects the terminating date and time of the call and finishes the optional recording (1527). Next, mobile phone call activity tracker 1500 queues the contact's phone number, originating date and time, terminating date and time, calculated difference between the originating date and time and terminating date and time, the geographical location (first information), and optional recording for transmission to contact management facility (CMF) 1100 (1528). Next, mobile phone call activity tracker 1500 determines if it ordinarily executes on the same processing unit as contact management facility 1100 (1529). If it does, mobile phone call activity tracker 1500 transfers any queued call information directly to contact management facility 1100 (1530). If not, mobile phone call activity tracker 1500 determines if it can create a network connection via PAN network 1300 or the Internet 1301 to contact management facility 1100 (1531). If it can, mobile phone call activity tracker 1500 transmits any queued call information to contact management facility 1100 (1532). If it cannot, mobile phone call activity tracker 1500 queues newly prepared call information for subsequent transmission to contact management facility 1100 when connected to contact management facility 1100 via PAN network 1300 or the Internet 1301 (1533).

Of course, the sales professional may use contact management facility 1100 to schedule that a mobile phone call be made to a particular contact at some future date and time. After queuing the sales professional's desire to place a mobile phone call at a later date and time, contact management facility 1100 determines if it ordinarily executes on the same processing unit as mobile phone call activity tracker 1500 (i.e. if mobile phone call activity tracker 1500 is on the same device as contact management facility 1100). If it does (or is), contact management facility 1100 transfers any queued mobile phone call scheduling information directly to mobile phone call activity tracker 1500 and mobile phone call activity tracker 1500 displays a prompt on the sales professional's local device (1535). If it does not, (i.e. mobile phone call activity tracker 1500 is on a remote device), contact management facility 1100 determines if it can create a network connection via PAN network 1300 or the Internet 1301 to remote mobile phone call activity tracker 1500. If it can, contact management facility 1100 transmits queued mobile phone call scheduling information to remote mobile phone call activity tracker 1500, remote mobile phone call tracker 1500 displays a prompt on the remote device (1535). If it cannot, contact management facility 1100 subsequently transmits queued mobile phone call scheduling information to remote mobile phone call activity tracker 1500 when connected to remote mobile phone call activity tracker 1500 via PAN network 1300 or the Internet 1301. Remote mobile phone call activity tracker 1500 then displays a prompt on the remote device (1535). When the sales professional subsequently places the scheduled mobile phone call, the process outlined above in ¶[0062] governing outgoing mobile phone calls is invoked.

As the sales professional makes or takes calls to, or from, a particular contact, respectively, contact management facility 1100 may from time to time provide status updates concerning the sales professional's economic efficiency with respect to that contact or any other contact or group of contacts. If so, mobile phone activity tracker 1500 displays these status updates in real-time as they arrive on the sales professional's device (1536).

Finally, in the context of the foregoing discussion it will be readily understood that in lieu of determining if mobile phone activity tracker 1500 resides with, is permanently connected to, or is transiently connected to, contact management facility 1100 as discussed above, special purpose versions of mobile phone activity tracker 1500 may be created that are specific for each of the three described situations (i.e. residing with contact management facility 1100, permanently connected to contact management facility 1100, or transiently connected to contact management facility 1100).

Referring now to FIG. 3, VOIP call activity tracker 1500 determines when a VOIP call is made to, or received from, a particular contact. VOIP call activity tracker 1500 captures and supplies the phone number, SIP URI, or VOIP user ID, date, time, the time spent making or taking the call, video call, or video conference, geographical location, respectively (first information), and optionally an audio or video recording of the call, video call, or video conference to contact management facility 1100 for storage in contact database 1200 associated with the contact or contacts to whom, or from whom, the VOIP call, video call, or video conference was made to or received from. In the disclosed embodiment, and without limitation, the sales professional makes and receives VOIP calls, video call, and video conferences using a Google Voice VOIP calling client installed on his or her cellular telephone. VOIP call activity tracker 1500 is ordinarily implemented as a standalone service routine running independently on the remote web-server. For example, VOIP call activity tracker 1500 may be implemented using the API offered in conjunction with the Google Voice VOIP calling server. Of course, support for VOIP calling servers changes over time and new VOIP servers working atop new VOIP providers arrive in the marketplace every day. For example, Ozeki Systems Ltd. provides a Windows .NET-based VOIP calling system that supports popular VOIP provider Callcentric®. Indeed, there are numerous VOIP servers working in conjunction with numerous VOIP providers on numerous types of operating systems and hardware platforms such as mobile phones and tablet computers and all are equally amenable to the present teaching.

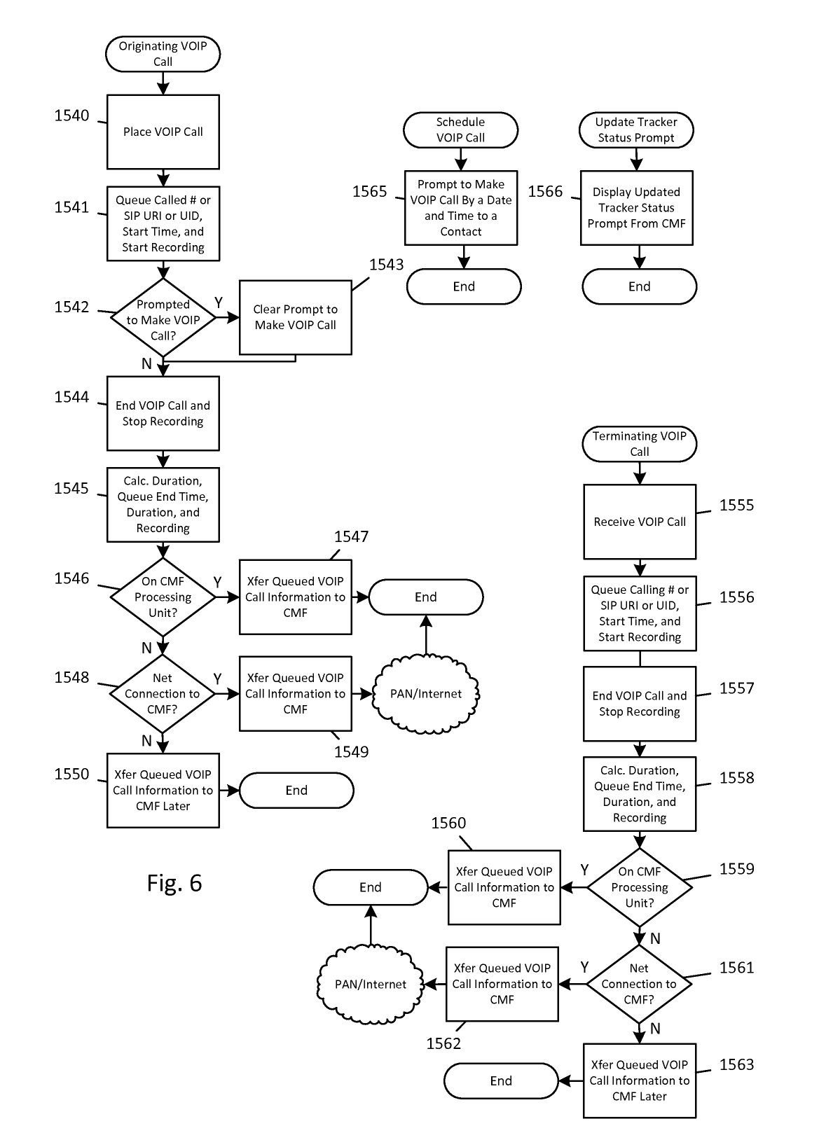

Referring now to FIG. 3 and FIG. 6, a process flowchart illustrating the operation of VOIP call activity tracker 1500 is provided. To make a VOIP call, the sales professional uses his or her cellular telephone to place a call or video call to the contact (1540). Next, VOIP call activity tracker 1500 collects the called contact's phone number, SIP URI, or VOIP user ID, the originating date and time of the call, geographical location and optionally (if legally permitted) begins an audio or video recording of the call (1541). Next, VOIP call activity tracker 1500 determines if it had been directed to visually prompt the sales professional to make the call (1542). If so, VOIP call activity tracker 1500 clears the visual prompt (1543). Next, the call ends and any optional recording stops (1544). Next, VOIP call activity tracker 1500 queues the contact's phone number, SIP URI, or VOIP user ID, originating date and time, terminating date and time, calculated difference between the originating date and time, and geographical location (first information), and any optional audio or video recording for transmission to contact management facility 1100 (1545). Next, VOIP call activity tracker 1500 determines if it ordinarily executes on the same processing unit as contact management facility 1100 (1546). If it does, VOIP call activity tracker 1500 transfers any queued call information directly to contact management facility 1100 (1547). If not, VOIP call activity tracker 1500 determines if it can create a network connection via PAN network 1300 or the Internet 1301 to contact management facility 1100 (1548). If it can, VOIP call activity tracker 1500 transmits any queued call information to contact management facility 1100 (1549). If it cannot, VOIP call activity tracker 1500 queues newly prepared call information for subsequent transmission to contact management facility 1100 when connected to contact management facility 1100 via PAN network 1300 or the Internet 1301 (1550).

When receiving a VOIP call, the sales professional answers the call using his VOIP calling client as he or she normally does (1555). VOIP call activity tracker 1500 collects the calling contact's phone number, SIP URI, or VOIP user ID, the originating date and time of the call, the geographical location (first information) and optionally begins an audio or video recording (if legally permitted) of the call (1556). Next, when the call concludes, VOIP call activity tracker 1500 collects the terminating date and time of the call and finishes any optional recording (1557). Next, VOIP call activity tracker 1500 queues the contact's phone number, SIP URI, or VOIP user ID, originating date and time, terminating date and time, calculated difference between the originating date and time, and geographical location (first information), and any optional audio or video recording for transmission to contact management facility 1100 (1558). Next, VOIP call activity tracker 1500 determines if it ordinarily executes on the same processing unit as contact management facility 1100 (1559). If it does, VOIP call activity tracker 1500 transfers any queued call information directly to contact management facility 1100 (1560). If not, VOIP call activity tracker 1500 determines if it can create a network connection via PAN network 1300 or the Internet 1301 to contact management facility 1100 (1561). If it can, VOIP call activity tracker 1500 transmits any queued call information to contact management facility 1100 (1562). If it cannot, VOIP call activity tracker 1500 queues newly prepared call information for subsequent transmission to contact management facility 1100 when connected to contact management facility 1100 via PAN network 1300 or the Internet 1301 (1563).

Of course, the sales professional may use contact management facility 1100 to schedule that a VOIP call be made to a particular contact at some future date and time. After queuing the sales professional's desire to place a VOIP call at a later date and time, contact management facility 1100 determines if it ordinarily executes on the same processing unit as VOIP call activity tracker 1500 (i.e. if VOIP call activity tracker 1500 is on the same device/web-server as contact management facility 1100). If it does (or is), contact management facility 1100 transfers any queued VOIP call scheduling information directly to VOIP call activity tracker 1500 and VOIP call activity tracker 1500 displays a prompt on the sales professional's local device (1565). If it does not, (i.e. VOIP call activity tracker 1500 is on a remote device), contact management facility 1100 determines if it can create a network connection via PAN network 1300 or the Internet 1301 to remote VOIP call activity tracker 1500. If it can, contact management facility 1100 transmits queued VOIP call scheduling information to remote VOIP call activity tracker 1500, remote VOIP call tracker 1500 displays a prompt on the remote device (1565). If it cannot, contact management facility 1100 subsequently transmits queued VOIP call scheduling information to remote VOIP call activity tracker 1500 when connected to remote VOIP call activity tracker 1500 via PAN network 1300 or the Internet 1301. Remote VOIP call activity tracker 1500 then displays a prompt on the remote device (1565). When the sales professional subsequently places the scheduled VOIP call, the process outlined above in ¶[0068] governing outgoing VOIP calls is invoked.

As the sales professional makes or takes VOIP calls to, or from, a particular contact, respectively, contact management facility 1100 may from time to time provide status updates concerning the sales professional's economic efficiency with respect to that contact or any other contact or group of contacts. If so, VOIP call activity tracker 1500 displays these status updates in real-time as they arrive on the sales professional's device (1566).

Finally, in the context of the foregoing discussion it will be readily understood that in lieu of determining if VOIP call activity tracker 1500 resides with, is permanently connected to, or is transiently connected to, contact management facility 1100 as discussed above, special purpose versions of VOIP call activity tracker 1500 may be created that are specific for each of the three described situations (i.e. residing with contact management facility 1100, permanently connected to contact management facility 1100, or transiently connected to contact management facility 1100).

Referring now to FIGS. 1, 2, and 3, text message activity tracker 1600 determines when a text or MMS message is sent to, or received from, a particular contact. Text message activity tracker 1600 captures and supplies the phone number, date, time, text, geographical location, and any attachments comprising the text or MMS message and time spent composing or reading the text or MMS message, respectively (first information), to contact management facility 1100 for storage in contact database 1200 associated with the contact to whom, or from whom, the text or MMS message was sent or received. Since text or MMS message clients in the prior art ordinarily do not record the time spent composing and/or reading text or MMS messages, in the disclosed embodiments the sales professional creates and receives text or MMS messages on a custom text or MMS message client capable of measuring and recording the time spent (first information) composing and reading text or MMS messages to, or from, a particular contact, respectively. As a result, text message activity tracker 1600 is ordinarily, but not necessarily, implemented as part of the custom text messaging client. Alternately, text message activity tracker 1600 may be implemented as a standalone service routine used in conjunction with conventional Android or iOS text or MMS message clients. In this implementation the phone number, time, date, text, geographical location, and any attachments associated with the text or MMS message may be collected, but the time spent (first information) composing and or reading text or MMS messages to, or from, a particular contact, respectively will be unavailable. While, the latter text message activity tracker 1600 may run in real time or periodically on a scheduled basis accessing the text or MMS messages stored by the text or MMS message client, the preferred embodiment of the present invention requires that the custom text messaging client with integral text message activity tracker 1600 run at all times so that accurate measurements of composition and reading time may be measured.

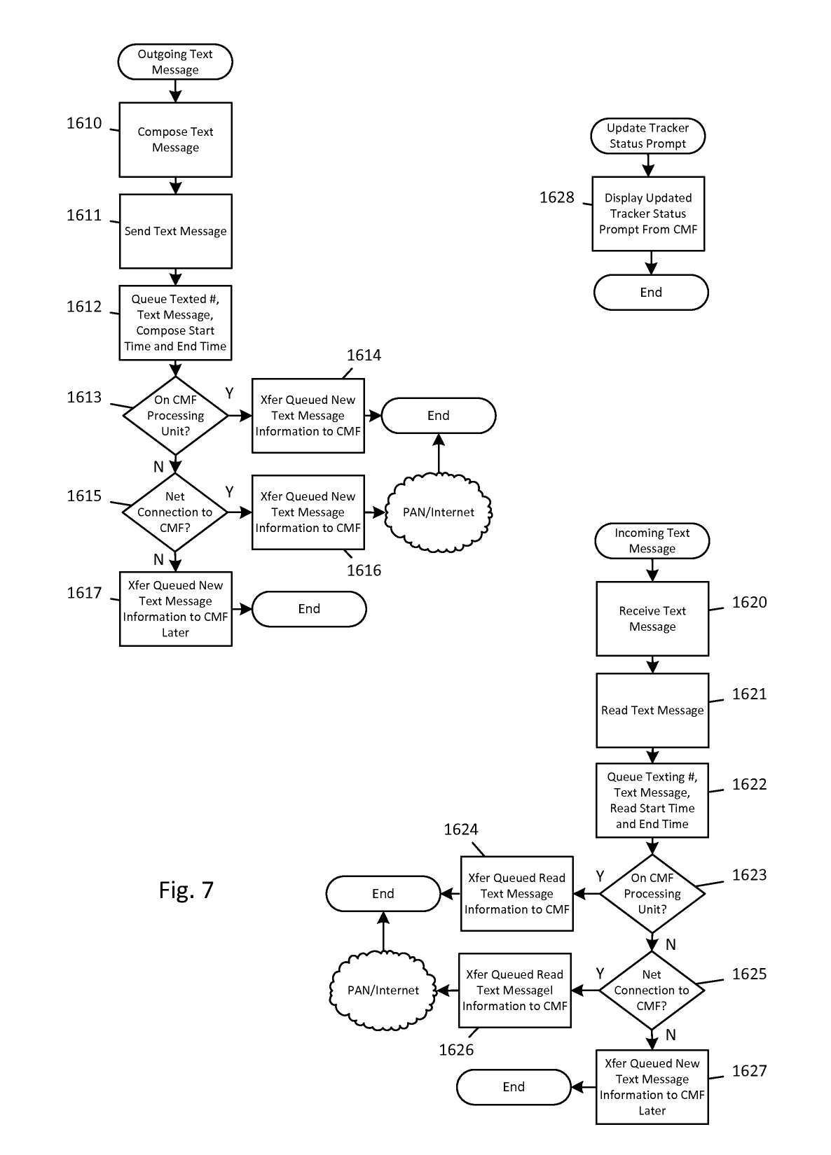

Referring now to FIGS. 1, 2, 3, and FIG. 7, a process flowchart illustrating the operation of text message activity tracker 1600 is provided. To send a text or MMS message, the sales professional composes a text or MMS message to a contact preferably using a custom Android or iOS text or MMS messaging client as described above (1610). Next, the sales professional sends the text or MMS message in the usual way via his text or MMS message client (1611). Next, when the text or MMS message is sent, text message activity tracker 1600 acquires the phone number, date, time, text, comprising the text or MMS message, geographical location and the amount of time the sales professional spent composing the text or MMS message (first information) and queues them for transmission to contact management facility 1100 (1612). Next, text message activity tracker 1600 determines if it ordinarily executes on the same processing unit as contact management facility 1100 (1613). If it does, text message activity tracker 1600 transfers any queued text or MMS message information directly to contact management facility 1100 (1614). If not, text message activity tracker 1600 determines if it can create a network connection via PAN network 1300 or the Internet 1301 to contact management facility 1100 (1615). If it can, text message activity tracker 1600 transmits any queued text or MMS message information to contact management facility 1100 (1616). If it cannot, text message activity tracker 1600 queues newly prepared text or MMS message information for subsequent transmission to contact management facility 1100 when connected to contact management facility 1100 via PAN network 1300 or the Internet 1301 (1617).

Preferably the sales professional uses the custom Android or iOS text or MMS messaging client as described above to receiving a text or MMS message (1620). After receiving a test or MMS message, the sales professional reads it in the usual way via his text or MMS message client (1621). Next, after text or MMS message is read, text message activity tracker 1600 acquires the phone number, date, time, text, geographical location, and any attachments comprising the text or MMS message and the amount of time the sales professional spent reading the text or MMS message (first information) and queues them for transmission to contact management facility 1100 (1622). Next, text message activity tracker 1600 determines if it ordinarily executes on the same processing unit as contact management facility 1100 (1623). If it does, text message activity tracker 1600 transfers any queued text or MMS message information directly to contact management facility 1100 (1624). If not, text message activity tracker 1600 determines if it can create a network connection via PAN network 1300 or the Internet 1301 to contact management facility 1100 (1625). If it can, text message activity tracker 1600 transmits any queued text or MMS message information to contact management facility 1100 (1626). If it cannot, text message activity tracker 1600 queues newly prepared text or MMS message information for subsequent transmission to contact management facility 1100 when connected to contact management facility 1100 via PAN network 1300 or the Internet 1301 (1627).

As the sales professional composes or reads text massages to, or from, a particular contact, respectively, contact management facility 1100 may from time to time provide status updates concerning the sales professional's economic efficiency with respect to that contact or any other contact or group of contacts. If so, text message activity tracker 1600 displays these status updates in real-time as they arrive on the sales professional's device (1628).

Finally, in the context of the foregoing discussion it will be readily understood that in lieu of determining if text message activity tracker 1600 resides with, is permanently connected to, or is transiently connected to, contact management facility 1100 as discussed above, special purpose versions of text message activity tracker 1600 may be created that are specific for each of the three described situations (i.e. residing with contact management facility 1100, permanently connected to contact management facility 1100, or transiently connected to contact management facility 1100).

The activity trackers described in detail in foregoing ¶¶[0056]-[0077] track different types of “electronic transactions” (i.e. email messages, mobile phone calls, VOIP calls, and text messages). It will be readily apparent to one having skill in the art that this foregoing list of electronic transaction types is by no means exhaustive. For example, activity trackers that: 1) Collect the time (first information) that a particular contact listens to one or more pre-recorded voice messages in a voice message system or phone support tree; 2) Collect the time (first information) that a particular contact is engaged in a video-conference call with the sales professional; 3) Collect the time (first information) that a particular contact is engaged in a textual or multimedia web-chat session with the sales professional; 4) Collect the time and geographic location (first information) that a particular contact is engaged in reviewing one or more web pages associated with one or more websites; 5) Collect the time and geographic location (first information) that a particular contact is physically located at or near a location; and, 6) Collect the time and geographic location (first information) that the sales professional is engaged in composing or editing a document, spreadsheet, drawing, or the like, are considered obvious in the scope of the present invention and thus implicitly included in the spirit and scope of the present invention.

Referring now to FIGS. 1, 2, and 3, GPS location activity tracker 1700 determines the location of the sales professional's mobile phone from the GPS receiver integral to the mobile phone or laptop computer. Location information collected by GPS location activity tracker 1700 is innately unrelated to any particular contact. Thus, when GPS location activity tracker 1700 collects and transmits the date, time, and location of the sales professional's mobile phone to contact management facility 1100, contact management facility 1100 must determine the individual contact with whom the location information is to be associated. For example, GPS location activity tracker 1700 may initially transmit location information correlating to the sales professional's known office or home address. Presuming the sales professional schedules and appears at an open house, for example, at a particular contact's listed residential property, GPS location activity tracker 1700 will return location information placing the sales professional at the contact's listed residential property during the time of the open house. When the sales professional returns to his or her office after the open house, contact management facility 1100 calculates the time the sales professional was traveling to, at, and returning from the contact's listed residential property (first information) and the distance traveled and stores them in contact database 1200 as a trip associated with the contact for whom the open house was conducted. As another example, assume a real estate sales professional schedules a property walk-through at a residential property a new client wishes to have the sales professional market for him. GPS location activity tracker 1700 operates such that when the sales professional drives to, arrives at, and departs from the new client's residential property, GPS location activity tracker 1700 returns location information placing the sales professional at the new client's property for the walkthrough. After the sales professional returns to his or her office, contact management facility 1100 calculates the time the sales professional was traveling to, at, and returning from the new client's listed residential property (first information) and distance traveled and stores them in contact database 1200 as a trip associated with the new client with whom the walkthrough was conducted. Ordinarily, GPS location activity tracker 1700 may be implemented as a standalone service routine used in conjunction with conventional Android or iOS based mobile phones equipped with GPS receivers. While GPS location activity tracker 1700 may run in real time or periodically on a scheduled basis, the preferred embodiment of the present invention requires that the GPS location activity tracker run in real time (while optionally periodically disabling the GPS receiver to conserve battery power) to ensure that real-time status prompts from contact management facility 1100 may be displayed.

Of course, those having skill in the art will recognize that numerous alternatives to GPS location technology are available. Some are based on deployed or planned satellite technology such as GLONASS (deployed) and Galileo, the Indian Regional Navigational Satellite System, and Compass (planned). Still others are based on wireless networking technologies like Wi-Fi and Bluetooth. For example, Google has amassed a vast database of Wi-Fi router IP addresses correlated to approximate latitude-longitude coordinates. By this means, simply identifying that a particular Wi-Fi router is nearby implies the sales professional's mobile phone is near a particular latitude and longitude. While potentially less accurate than GPS derived location information, such information is available indoors out of sight of GPS satellites. Those having skill in the art will readily recognize that in the following discussion, such technologies represent fully equivalent means of securing acceptable location information and all such technological variants are implicitly included in the spirit and scope of the present invention.

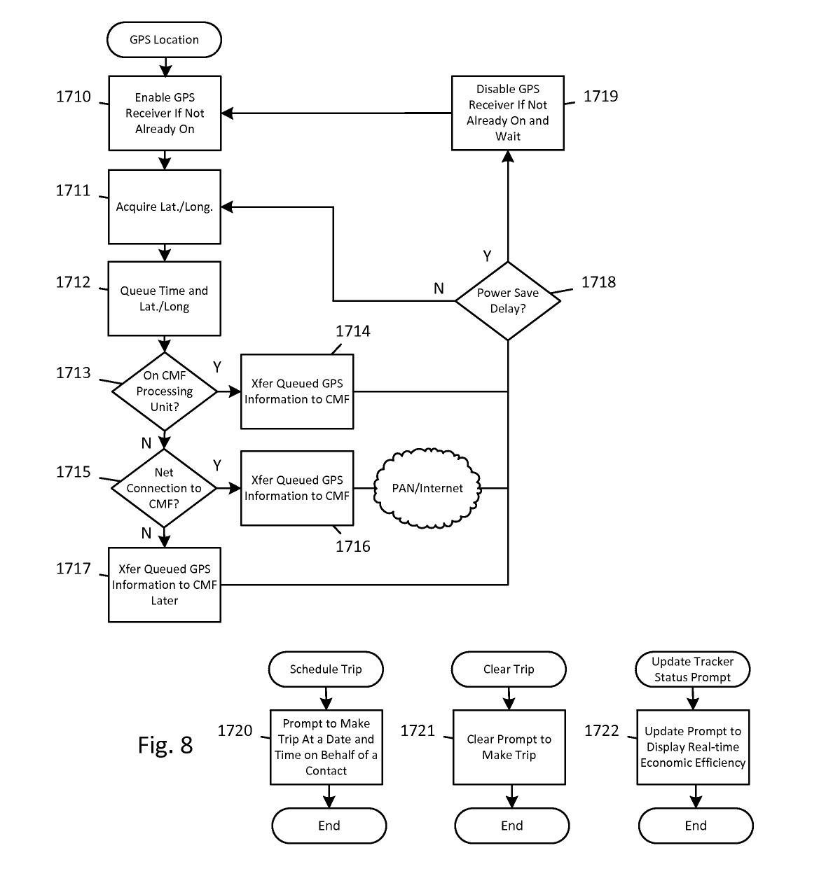

Referring now to FIGS. 1, 2, 3, and FIG. 8, a process flowchart illustrating the operation of GPS location activity tracker 1700 is provided. As mentioned earlier, GPS location activity tracker 1700 preferably runs at all times on the sales professional's mobile phone or laptop computer. First, GPS location activity tracker 1700 enables the mobile phone's GPS receiver (1710). Next, after acquiring sufficient GPS signals to calculate the sales professional's location, GPS location activity tracker 1700 acquires a latitude-longitude pair (1711). Next, after an acceptable latitude-longitude location pair has been acquired, GPS location activity tracker 1700 acquires the date and time at which the latitude-longitude pair was acquired and queues the latitude-longitude pair and the acquisition date and time for transmission to contact management facility 1100 (1712). Next, GPS location activity tracker 1700 determines if it ordinarily executes on the same processing unit as contact management facility 1100 (1713). If it ordinarily executes on the same processing unit as contact management facility 1100, GPS location activity tracker 1700 transfers any queued GPS information directly to contact management facility 1100 (1714) and proceeds to determine if GPS location activity tracker 1700 is to disable the GPS receiver and wait for a period of time before acquiring another latitude-longitude pair (1718). If not, GPS location activity tracker 1700 repeats the process by acquiring another latitude-longitude pair (1711). If so, GPS location activity tracker 1700 disables the GPS receiver and waits (1719). After waiting, GPS location activity tracker 1700 enables the GPS receiver (1710) and the process repeats. If GPS location activity tracker 1700 does not ordinarily execute on the same processing unit as contact management facility 1100, GPS location activity tracker 1700 determines if it can create a network connection via PAN network 1300 or the Internet 1301 to contact management facility 1100 (1715). If it can, GPS location activity tracker 1700 transmits any queued location information to contact management facility 1100 (1716) and proceeds to determine if GPS location activity tracker 1700 is to disable the GPS receiver and wait for a period of time before acquiring another latitude-longitude pair (1718). If not, GPS location activity tracker 1700 repeats the process by acquiring another latitude-longitude pair (1711). If so, GPS location activity tracker 1700 disables the GPS receiver and waits (1719). After waiting, GPS location activity tracker 1700 enables the GPS receiver (1710) and the process repeats. If GPS location activity tracker 1700 determines it cannot create a network connection via PAN network 1300 or the Internet 1301 to contact management facility 1100, GPS location activity tracker 1700 must transfer queued GPS information at a later time (1717). Finally, GPS location activity tracker 1700 proceeds to determine if it is to disable the GPS receiver and wait for a period of time before acquiring another latitude-longitude pair (1718). If not, GPS location activity tracker 1700 repeats the process by acquiring another latitude-longitude pair (1711). If so, GPS location activity tracker 1700 disables the GPS receiver and waits (1719). After waiting, GPS location activity tracker 1700 enables the GPS receiver (1710) and the process repeats. Those having skill in the art will recognize that a variant of this process must be used when other tasks are utilizing the GPS receiver to ensure that the GPS receiver is not improperly disabled.

Of course, the sales professional may use contact management facility 1100 to schedule that a trip or meeting be made on behalf of a particular contact at some future date and time. After queuing the sales professional's desire to place trip or meeting on behalf of a contact at a specific location at some specific later date and time, contact management facility 1100 determines if it ordinarily executes on the same processing unit as GPS location activity tracker 1700 (i.e. if GPS location activity tracker 1700 is on the same device as contact management facility 1100). If it does (or is), contact management facility 1100 transfers any queued trip/meeting scheduling and location information directly to GPS location activity tracker 1700 and GPS location activity tracker 1700 displays a prompt on the sales professional's local device (1720). If it does not (i.e. GPS location activity tracker 1700 is on a remote device), contact management facility 1100 determines if it can create a network connection via PAN network 1300 or the Internet 1301 to remote GPS location activity tracker 1700. If it can, contact management facility 1100 transmits queued trip/meeting scheduling and location information to remote GPS location activity tracker 1700, remote GPS location activity tracker 1700 displays a prompt on the remote device (1720). If it cannot, contact management facility 1100 subsequently transmits queued trip/meeting scheduling to remote GPS location activity tracker 1700 when connected to remote GPS location activity tracker 1700 via PAN network 1300 or the Internet 1301. Remote GPS location activity tracker 1700 then displays a prompt on the remote device (1720). When the sales professional subsequently undertakes the prompted trip or meeting, the process outlined above in ¶[0081] governing traveling in conjunction with trips or meetings is invoked.

In this embodiment of the present invention, contact management facility 1100 determines when, or if, the sales professional has undertaken, or completed, a scheduled trip. Ordinarily this would be done by comparing the ending destination (or a waypoint) for a scheduled trip and the most recently acquired latitude-longitude pair from GPS location activity tracker 1700. By this means the prompt displayed on the sales professional's device prompting him of her to undertake the trip may be cleared (1721).

As the sales professional travels on behalf of a particular contact, contact management facility 1100 may from time to time provide status updates concerning the sales professional's economic efficiency with respect to that contact or any other contact or group of contacts. If so, GPS location activity tracker 1700 displays these status updates in real-time as they arrive on the sales professional's device (1722).

Finally, in the context of the foregoing discussion it will be readily understood that in lieu of determining if GPS location activity tracker 1700 resides with, is permanently connected to, or is transiently connected to, contact management facility 1100 as discussed above, special purpose versions of GPS location activity tracker 1700 may be created that are specific for each of the three described situations (i.e. residing with contact management facility 1100, permanently connected to contact management facility 1100, or transiently connected to contact management facility 1100).

The activity tracker described in detail in foregoing ¶¶[0079]-[0085] tracks different types of “other activities” (i.e. trips, meetings, and tasks ordinarily conducted away from the sales professional's home or office). It will be readily apparent to those having skill in the art that this foregoing other activity tracker is not unique. For example, activity trackers that: 1) Collect the time (first information) and distance traveled by a particular vehicle, vessel, or aircraft when in route to and/or from a contact's physical location; and, 2) Collect the time (first information) and distance traveled by a particular parcel, package, or container when in route to and/or from a contact's physical location are considered obvious in the scope of the present invention. Of course, it is entirely obvious that geographically related GPS information may be recorded when it occurs or merely predicted to occur.

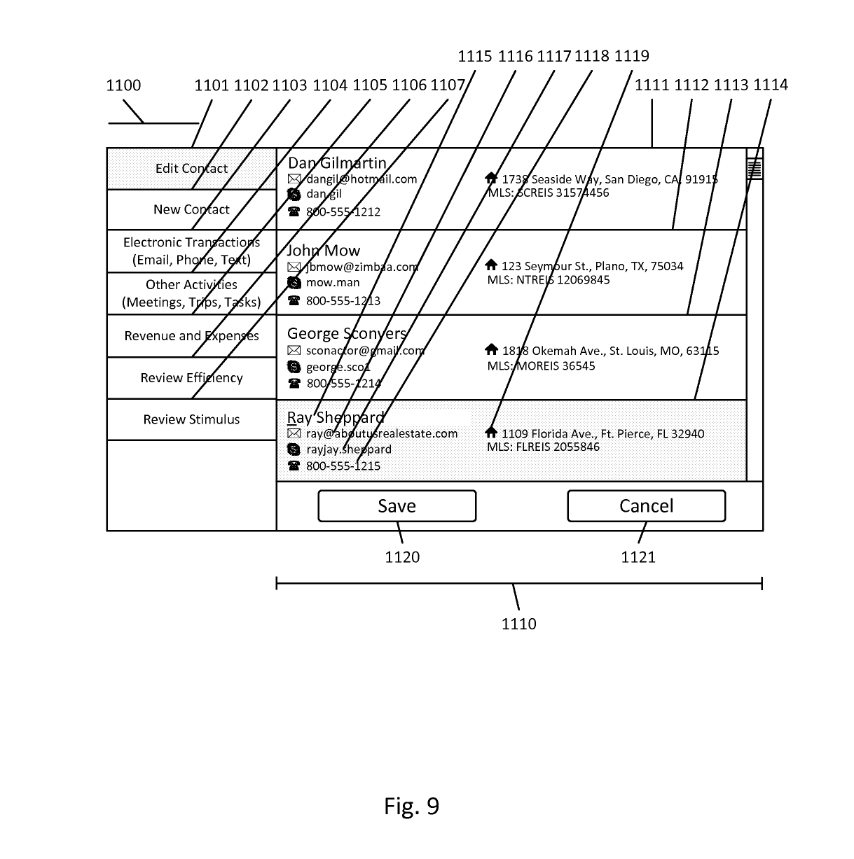

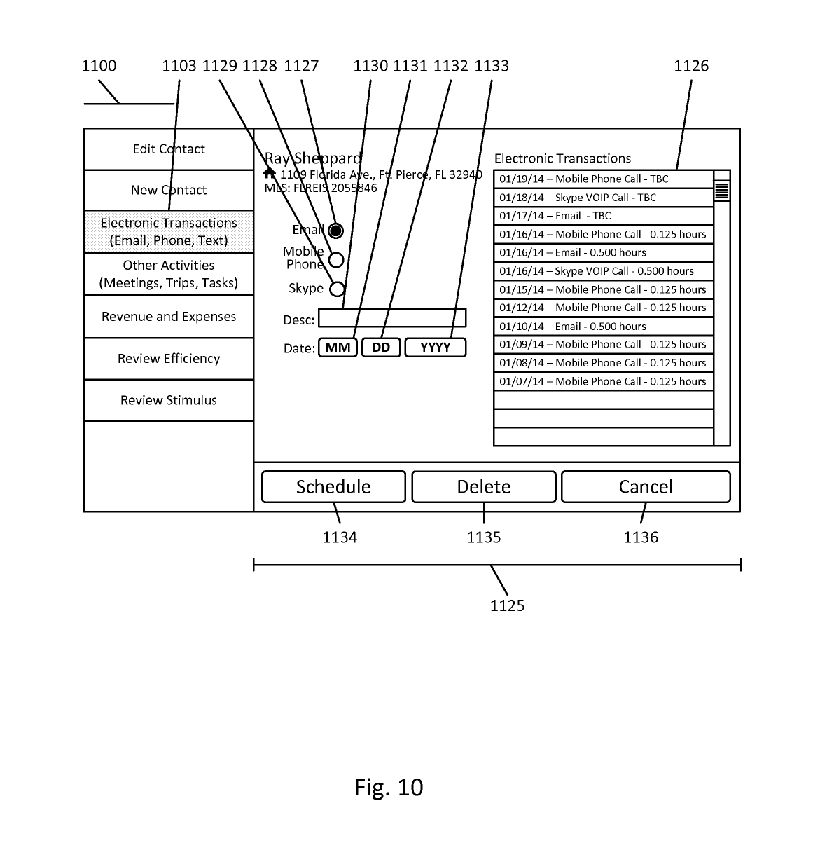

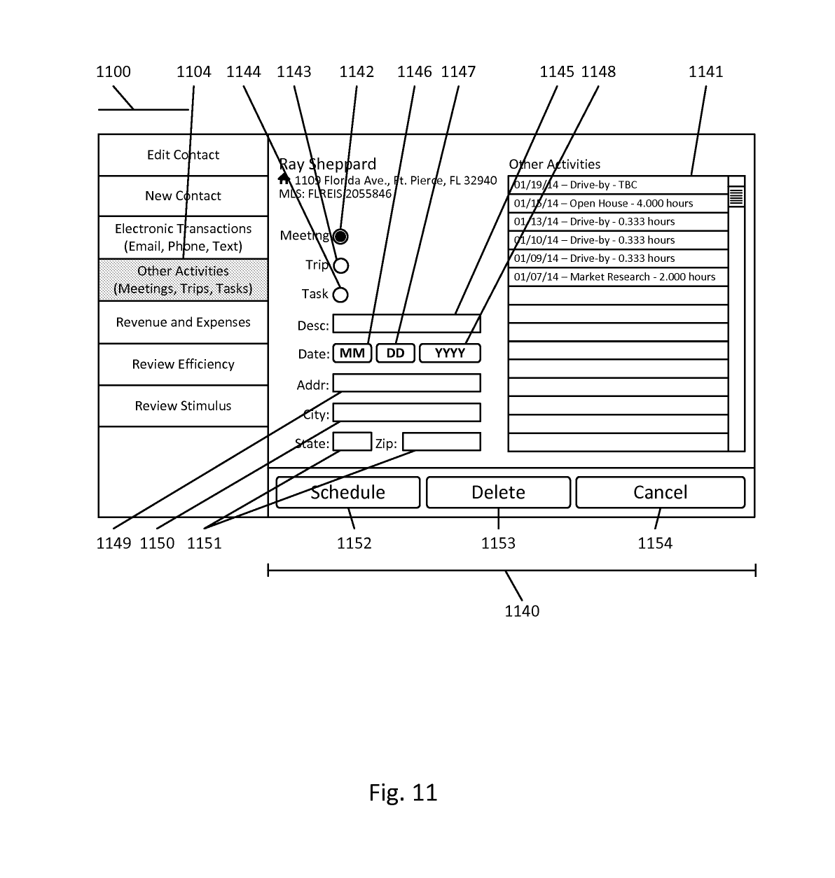

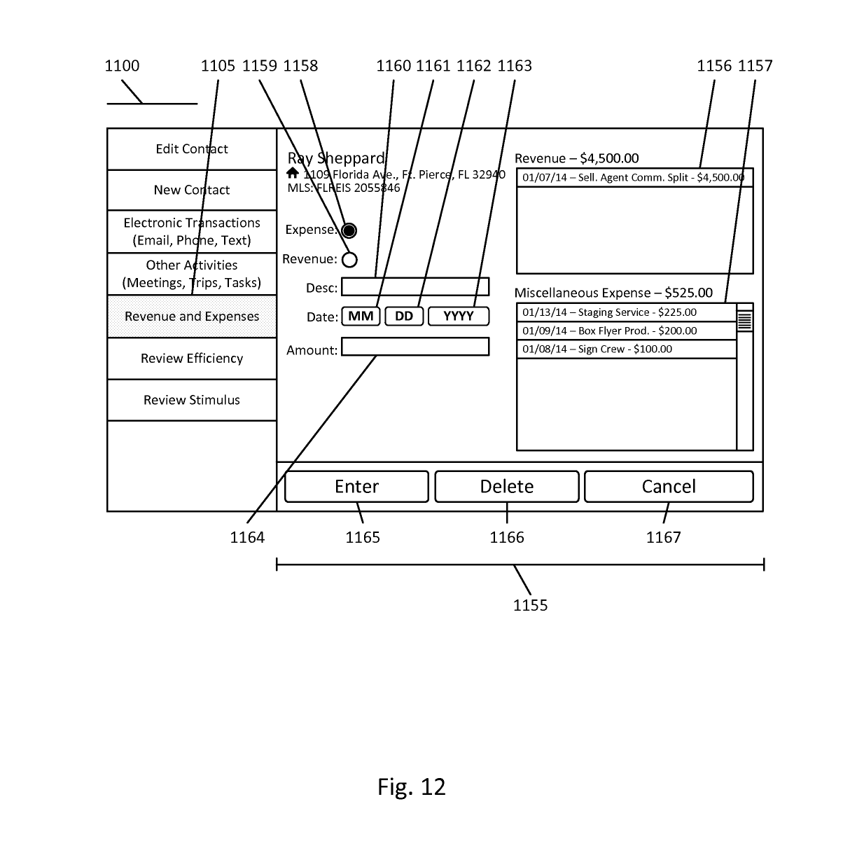

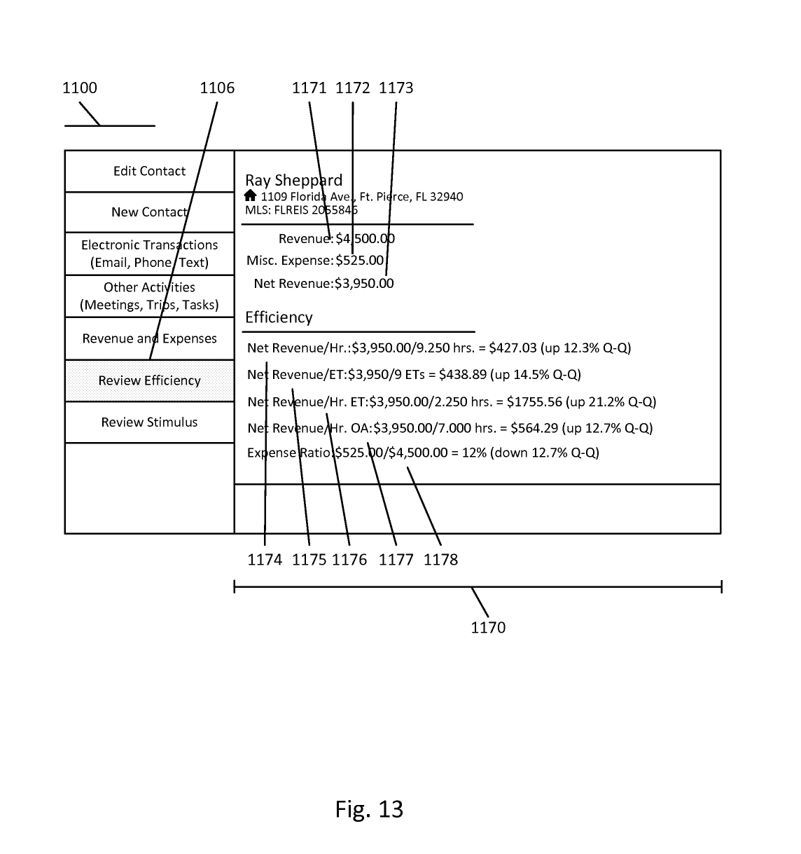

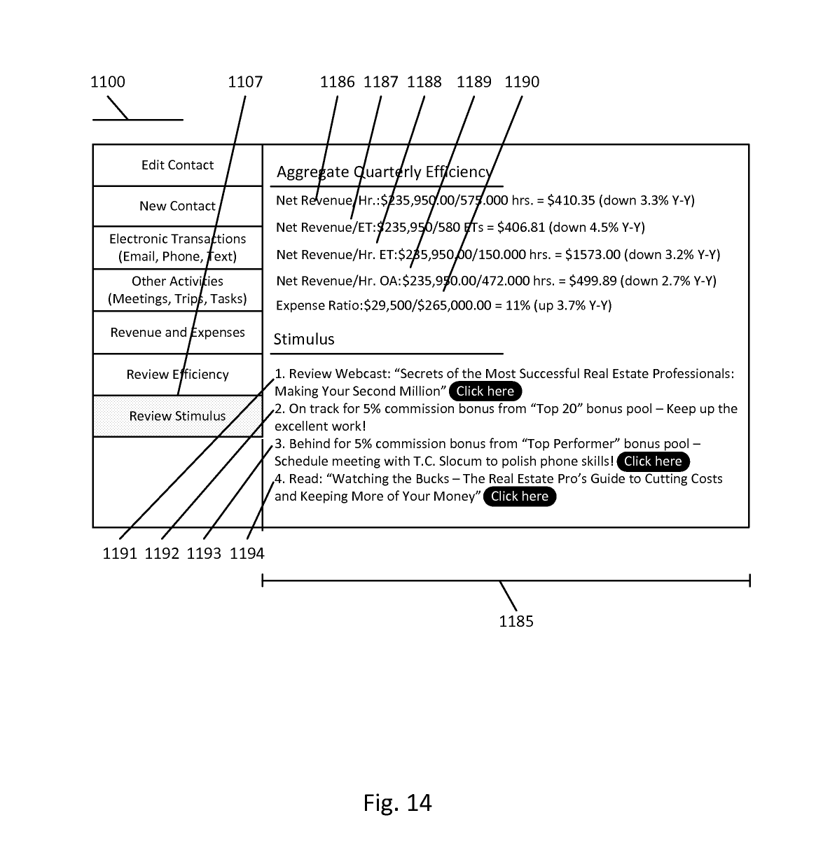

Referring now to FIGS. 9 through 14, an exemplary, non-limiting implementation of a user interface of a distributed GPS-based sales efficiency management system of the present invention according to one embodiment of the present invention is displayed. As do all other contact managers in the prior art, contact management facility 1100 allows the sales professional to create, edit, and save identifying, characterizing, and activity related information pertaining to a particular contact, including: 1) The ability to list, retrieve, and edit existing contact records in contact database 1200; 2) The ability to create and edit new contact records in contact database 1200; 3) The ability to schedule calls, emails, meetings, and tasks on behalf of a particular contact; and, 4) The ability to review records of past calls, emails, meetings, and tasks undertaken on behalf of a particular contact. Accordingly, since the above functionality is notoriously ubiquitous in the prior art some details associated with the above operations will not be described further here so as to not detract from the essential improvements incorporated in the present invention. The referenced user interface may be generated by the client device itself or by a remote web-server.

The main display of contact management facility 1100 of this exemplary, non-limiting implementation of distributed GPS-based sales efficiency management system provides a series of information displays portraying salient information about individual contacts and the sales professional's current economic efficiency with respect to them, both individually and in the aggregate. Along the left side of the main display of contact management facility 1100, a series of control areas are provided that may be individually selected each of which activates a particular information display. In this exemplary, non-limiting implementation the following information screens may be selected: 1) Edit Contact 1101; 2) New Contact 1102; 3) Electronic Transactions 1103; 4) Other Activities 1104; 5) Revenue and Expenses 1105; 6) Review Efficiency 1106; and, 7) Review Stimulus 1107.

Referring to FIGS. 1 and 9, when this exemplary embodiment of contact management facility 1100 is first viewed, contact list display 1110 is populated with a list of contact records 1111, 1112, 1113, and 1114. In this particular example, the real estate sales professional has selected contact record 1114. In this embodiment, contact management facility 1100 stores the contact's name 1115, email address 1116, Google Voice user ID 1117, phone number 1118, and listed property address and MLS number 1119 in in each contact record in contact database 1200. Assuming further that the real estate sales professional selects Edit Contact 1101 after having selected contact 1114, the system highlights the selected contact's name 1115 and prepares the field to be edited. If the real estate sales professional makes changes in the field, the changes can be committed to contact database 1200 by selecting Save 1120. Otherwise, Cancel 1121 cancels the edits. The sales professional may select other fields in contact record 1114 to be edited and save or cancel the edits as described above.

As discussed above, the process of creating a new contact record that is triggered when the sales professional selects New Contact 1102 is notoriously ubiquitous in the prior art. Thus it will not be described in detail further here so as to not detract from the essential improvements incorporated in the present invention.

Referring now to FIGS. 1, 9, and 10, an exemplary, non-limiting implementation of user interface screen showing an electronic transaction display 1125 according to one embodiment of the present invention is shown. After selecting a particular contact as described previously from contact list display 1110, selecting Electronic Transactions 1103 shows an electronic transaction display 1125 pertaining specifically to the selected contact: In this case contact 1114. Electronic transaction display 1125 comprises electronic transaction list 1126 chronicling the electronic transactions undertaken, or to be undertaken, by the real estate sales professional on behalf of the contact. In this example, the real estate sales professional has undertaken, or will undertake, the following electronic transactions on behalf of contact 1114:

TABLE 3

| Date | Type | Time (hours) |
|---|---|---|
| Jan. 19, 2014 | Mobile Phone call | TBC |
| Jan. 18, 2014 | Google Voice VOIP call | TBC |
| Jan. 17, 2014 | Email | TBC |
| Jan. 16, 2014 | Mobile Phone Call | 0.125 |
| Jan. 16, 2014 | Email | 0.500 |
| Jan. 16, 2014 | Google Voice VOIP call | 0.500 |
| Jan. 15, 2014 | Mobile Phone Call | 0.125 |
| Jan. 12, 2014 | Mobile Phone Call | 0.125 |
| Jan. 10, 2014 | Email | 0.500 |
| Jan. 9, 2014 | Mobile Phone Call | 0.125 |
| Jan. 8, 2014 | Mobile Phone Call | 0.125 |
| Jan. 7, 2014 | Mobile Phone Call | 0.125 |
| | | 2.250 |

The first three electronic transactions shown in electronic transaction list 1126 are to be completed (TBC) and notices of these pending electronic transactions have been forwarded to the appropriate activity trackers: 1) Notice of the mobile phone call scheduled for 01/19/14 has been forwarded to mobile phone call activity tracker 1500 resident on the real estate professional's mobile phone; 2) Notice of the Google Voice VOIP call scheduled for 01/18/14 has been forwarded to VOIP call activity tracker 1500 resident on the real estate professional's laptop computer; and, 3) Notice of the email scheduled to be sent on 01/17/14 has been forwarded to email activity tracker 1400 also resident on the real estate professional's laptop computer. A pending (TBC) activity may be deleted by selecting it and selecting Delete 1135 whereupon a notice that a pending electronic transaction has been cancelled is forwarded to the appropriate activity tracker. New electronic transactions are scheduled by: 1) Designating the type of electronic transaction by ticking either: a) Email 1127; b) Mobile Phone 1128; or, c) Google Voice 1129; 2) Providing a brief description if desired in the Desc (description) text field 1130; 3) Designating a date and time for the new electronic activity by designating the desired values in: a) The MM (month) dropdown box 1131; b) The DD (day) drop down box 1132; and, c) The YYYY (year) drop down box 1133; and, 4) Selecting Schedule 1134 to commit the changes to contact database 1200. Alternately, the real estate sales professional may discard the proposed new electronic transaction by selecting Cancel 1136.

Referring now to FIGS. 1, 9, and 11, an exemplary, non-limiting implementation of user interface screen showing an other activity display 1140 according to one embodiment of the present invention is shown. After selecting a particular contact as described previously from contact list display 1110, selecting Other Activities 1104 shows the other activity display 1140 pertaining specifically to the selected contact: In this case contact 1114. Other activity display 1140 comprises other activity list 1141 chronicling the other activities undertaken, or to be undertaken, by the real estate sales professional on behalf of the contact. In this example, the real estate sales professional has undertaken, or will undertake, the following other activities on behalf of contact 1114:

TABLE 4

| Date | Type | Time (hours) |
|---|---|---|
| Jan. 19, 2014 | Drive-by | TBC |
| Jan. 15, 2014 | Open House | 4.000 |
| Jan. 13, 2014 | Drive-by | 0.333 |
| Jan. 10, 2014 | Drive-by | 0.333 |
| Jan. 9, 2014 | Drive-by | 0.333 |
| Jan. 7, 2014 | Market Research | 2.000 |
| | | 7.000 |

The first other activity shown in other activity list 1141 is to be completed (TBC) and a notice of this pending other activity and the time scheduled for the activity has been forwarded to the appropriate activity tracker: Notice of the drive-by scheduled for 01/19/14 has been forwarded to GPS location activity tracker 1700 resident on the real estate professional's mobile phone. A pending (TBC) activity may be deleted by selecting it and selecting Delete 1153 whereupon a notice that a pending electronic transaction has been cancelled is forwarded to the appropriate activity tracker. New other activities are scheduled by: 1) Designating the type of other activity by ticking either: a) Meeting 1142; b) Trip 1143; or, c) Task 1144; 2) Providing a brief description if desired in Desc (description) text field 1145; 3) Designating a date and time for the new electronic activity by designating the desired values in: a) The MM (month) dropdown box 1146; b) The DD (day) drop down box 1147; and, c) The YYYY (year) drop down box 1148; 4) Providing an address, city, state, and Zipcode® (if required) in the Addr (address) text field 1149, City text field 1150, and State and Zip (Zip code) text fields 1151, respectively; and, 5) Selecting Schedule 1152 to commit the changes to contact database 1200. Alternately, the real estate sales professional may discard the proposed other activity selecting Cancel 1154.

Referring now to FIGS. 1, 9, and 12, an exemplary, non-limiting implementation of user interface screen showing a revenue and expense display 1155 according to one embodiment of the present invention is shown. After selecting a particular contact as described previously from contact list display 1110, selecting Revenue and Expenses 1105 shows the revenue and miscellaneous expenses display 1155 pertaining specifically to the selected contact: In this case contact 1114. Revenue and expense display 1155 comprises revenue list 1156 chronicling the revenue derived from, or to be derived from, contact 1114:

TABLE 5

| Date | Type | Sale Amount | Rate | Extension |
|---|---|---|---|---|
| Jan. 7, 2014 | Commission | $150,000.00 | 3% | $4,500.00 |
| | | | | $4,500.00 |

In this example, the real estate professional anticipates a gross commission based on a 3% selling agent split of a predicted $150,000.00 closing price to be paid at closing. The real estate professional supplied this revenue amount after contracting with the contact to serve as the contact's selling agent and after having conducted market research to determine a likely sales price. In the alternative, the system may have automatically acquired the listing amount from an internal or external property listing system such as the MLS. Of course, the property may sell for less, or more, than the listed amount. When the real estate sales professional determines the proper amount of commission (revenue) to be forthcoming from the sale, he or she selects the predicted amount in revenue list 1156 and selects Delete 1166 to remove it. Next, the real estate sales professional: 1) Selects the Revenue radio button 1159; 2) Provides a brief description of the type of revenue via the Desc (description) text box (1160); 3) Designates a date and time for closing by designating the desired values in: a) The MM (month) dropdown box 1161; b) The DD (day) drop down box 1162; and, c) The YYYY (year) drop down box 1163; 4) Enters the amount of the new predicted or expected commission (revenue) via Amount text box 1164; and, 5) Selects Enter 1165 to commit the new predicted or expected commission (revenue) to contact database 1200 associated with contact 1114. Alternately, the real estate sales professional may discard the proposed change by selecting Cancel 1167. As above, in the alternative, the system may automatically acquire the sale amount from an internal or external property listing system such as the MLS. Further, it will be readily apparent that another member of the selling entity team that includes the real estate sales professional (e.g. an assistant, a manager, or an affiliated or unaffiliated real estate professional) may have supplied the above amount.

Revenue and expense display 1155 also comprises miscellaneous expense list 1157 chronicling the miscellaneous expenses incurred on behalf of contact 1114 including in this example, the real estate sales professional incurred the following miscellaneous expenses on the following dates.

TABLE 6

| Date | Type | Amount/Rate |
|---|---|---|
| Jan. 13, 2014 | Staging Service | $225.00 |
| Jan. 9, 2014 | Box Flyer Prod. | $200.00 |
| Jan. 8, 2014 | Sign Crew | $100.00 |
| | | $525.00 |

As above, miscellaneous expenses may erroneously entered and need revision. To delete a miscellaneous expense, the real estate professional selects the erroneous entry in miscellaneous expense list 1157 and selects Delete 1166 to remove it. If the real estate sales professional needs to associate another miscellaneous expense with the sale he or she: 1) Selects the Expense radio button 1158; 2) Provides a brief description of the type of expense via the Desc (description) text box (1160); 3) Designates the date and time at which the new expense was incurred by designating the desired values in: a) The MM (month) dropdown box 1161; b) The DD (day) drop down box 1162; and, c) The YYYY (year) drop down box 1163; 4) Enters the amount of the new expense via the Amount text box 1164; and, and, 5) Selects Enter 1165 to commit the new expense to contact database 1200 associated with contact 1114. Alternately, the real estate sales professional may discard the proposed change by selecting Cancel 1167. As above, in the alternative, the system may automatically acquire some or all of these amounts from an internal or external property listing system such as the MLS. Further, it will be readily apparent that another member of the selling entity team that includes the real estate sales professional (e.g. an assistant, a manager, an affiliated or unaffiliated real estate professional) or a third party subcontractor, supplier, or vendor) may have supplied one or more of the above amounts.

Referring now to FIGS. 1, 9, and 13, an exemplary, non-limiting implementation of user interface screen showing a review efficiency display 1170 according to one embodiment of the present invention is shown. After selecting a particular contact as described previously from contact list display 1110, selecting Review Efficiency 1106 shows the review efficiency display 1170 pertaining specifically to the selected contact: In this case contact 1114. Review efficiency display 1170 comprises basic economic data regarding the current status of the real estate sales professional's efforts on behalf of contact 1114. For example, total revenue derived, or expected from, contact 1114 is shown at 1171. Miscellaneous expenses are shown at 1172. Net revenue (the amount retained by the real estate sales professional) is the difference between revenue and total expenses and is shown at 1173.

The system dynamically calculates various efficiency ratios that can be used to compare the real estate sales professional's economic efficiency over time or against his or her peers. For example, net revenue per hour of the real estate sales professional's labor is show at 1174. Net revenue per electronic transaction (mobile phone calls, Google Voice VOIP calls, and emails) is shown at 1175. Net revenue per hour of labor undertaking electronic transactions (in this example, mobile phone calls, Google Voice VOIP calls, and emails) is shown at 1176. Net revenue per hour of other activities (in this example, an open house, three drive-bys, and market research) is shown at 1177. In this example, the system also compares the real estate sales professional's efficiency ratios servicing this contact to his or her aggregate ratios for the preceding quarter. Conventional economic ratios may also be prepared and displayed. For example, the expense ratio (the percent of miscellaneous expenses as a fraction of revenue) is shown at 1178. Those having skill in the art will readily recognize that innumerable other economic efficiency ratios may be similarly calculated and displayed. Similarly, those having skill in the art will readily recognize that there are innumerable graphical, tabular, and other visual and audible methods of communicating these economic efficiency ratios to the real estate sales professional and/or the selling entity.

Calculating sales efficiencies as described above and using them to compare an individual real-estate professional's economic efficiency with various benchmarks makes it possible to determine if some kind of stimulus, such as a reward for superior performance, or, remediation for inferior effort, is appropriate. For example, a solo real estate sales professional might be rewarded by a series of reinforcing affirmations as his or her sales efficiency holds steady or improves over time. The same real estate sales professional might be remediated by a series of instructive or supportive affirmations if his or her sales efficiency falls over time or fails to improve enough over an extended period of time. The same real estate sales professional may be remediated by means of exposure to online or face-to-face training or instructive programs if sales efficiency stays low. In organized institutional sales environments, a reward may take the form of a financial incentive such as a bonus while remediation may take the form of a financial disincentive such as a reduction in expected payout from one or more transactions. Another type of incentive may be offered by comparing a group of similarly situated sales professionals selling similar goods or services over a fixed period of time and using the economic efficiency ratios thus derived as the basis of a sales efficiency contest. For example, the three most efficient salespeople over a fixed sales period may be awarded bonus payments for their superior performance versus their peers while the least efficient salespeople may be subject to online or face-to-face training.

Referring now to FIGS. 1, 9, 13, and 14, an exemplary, non-limiting implementation of user interface screen showing a review stimulus display 1185 according to one embodiment of the present invention is shown. Selecting Review Stimulus 1107 shows the review stimulus display 1185 summarizing stimulus actions derived from the aggregate quarterly efficiency of the real estate sales professional year-over-year. In this example, review stimulus display 1185 presents basic economic data regarding the current quarterly status of the real estate sales professional's efforts on behalf of all the contacts he or she is serving: Net revenue per hour of the real estate sales professional's labor is show at 1186. Net revenue per electronic transaction (e.g. mobile phone calls, Google Voice VOIP calls, text messages, and emails) is shown at 1187. Net revenue per hour of labor undertaking electronic transactions (in this example, mobile phone calls, Google Voice VOIP calls, and emails) is shown at 1188. Net revenue per hour of other activities (e.g. open houses, drive-bys, and market research) is shown at 1189. In this example, however, the system compares the real estate sales professional's aggregate quarterly efficiency ratios servicing all of his or her contacts to the equivalent ratios from the preceding year. Further, the system also compares the real estate sales professional's efficiency ratios servicing all of his or her contacts this quarter to his or her aggregate ratios for the preceding year as shown at 1190.

Here, we note that the real estate sales professional has strongly positive ratios servicing contact 1114 but serving all of his or her contacts the real estate professional has efficiency ratios that are slightly worse in all categories when compared to his or her efficiency ratios for last year. Accordingly, rewards or remediation might be appropriate. In this example, the system has selected four items: 1) The system has designated that the real estate sales professional review a particular webcast and has provided a hyper-link to access it (1191); 2) The system has determined that although the real estate sales professional's efficiency ratios are somewhat lower than last year, he or she remains on track for a “Top 20” bonus pool to be awarded to the top twenty performers amongst the real estate sales professional's peers. As a result, the system has offered an appropriate encouraging affirmation (1192); 3) The system has determined that the real estate sales professional has fallen behind in his or her quest to be the agency's top performer and has indicated that the real estate sales professional should schedule a meeting with a consultant to polish his or her phone skills. The system has also provided a hyper-link to schedule the conference (1193); and, 4) The system has automatically determined that the real estate sales professional's expense ratio is up when compared to the previous year, and has provided a hyper-link to a particular web-article for the real estate professional to read (1194).

Referring again to FIGS. 1, 2, and 3, it will be readily apparent to one having skill in the art that the above described embodiments of a distributed sales efficiency monitoring system are by no means exhaustive. For example, there is no requirement that only one activity tracker associated with one type of electronic transaction or other activity need be included in the system. Such a system may, for example, include VOIP call activity tracker 1500 on the sales professional's laptop for use with a VOIP calling client and mobile phone call activity tracker 1500 on the sales professional's mobile phone so that calls may be made and received via both devices and information regarding those calls subsequently stored by contact management facility 1100 in contact database 1200. Similarly, more than one email activity tracker 1400 may be included in the system, each on a different device, so that email may be sent and received via two different devices. Similarly, more than one text message activity tracker 1600 may be included in the system, each on a different device, so that text messages may be sent and received via two different devices. Similarly, more than one GPS location activity tracker 1700 may be included in the system, one in the sales professional's mobile phone and one affixed to the sales professional's car so that GPS coordinates may be sent and received via two different devices.

Moreover, it will be readily apparent to those having skill in the art that contact management facility 1100, contact database 1200, efficiency analysis facility 1800, stimulus generator 1900, email activity tracker 1400, and a functional email client may be combined into one application residing on the sales professional's laptop computer or cellular telephone and thus obviate the need for a standalone email activity tracker 1400. Similarly, it will be readily apparent to those having skill in the art that contact management facility 1100, contact database 1200, efficiency analysis facility 1800, stimulus generator 1900, email activity tracker 1400, and a functional VOIP calling client may be combined into one application residing on the sales professional's laptop computer or cellular telephone and obviate the need for a standalone VOIP Calling Activity Tracker 1500. Indeed, without limitation any combination of the functional elements of a distributed sales efficiency monitoring system of the present invention may be combined together on a single hardware device executing as a single application program. For example, it is conceivable that all of the functionality ascribed to the present invention may be combined into a single application operating on a single device, such as a mobile phone, or tablet computer, or functionally divided among numerous different devices each performing a single specific function.

Moreover, there is no limitation in terms of the numbers or types of activity trackers deployed in a particular system. For example, a system featuring only GPS location activity tracker 1700 may be used to collect data from a delivery driver's mobile phone or laptop computer and subsequently track the resulting economic efficiency data as the delivery driver attends to his or her daily rounds.

Indeed, any conceivable combination of hardware and software capable of collecting: 1) The amount of time a human being or a machine spends working on any conceivable transaction or activity on behalf of a contact (first information); and/or, 2) Amassing the number of times that a human being or a machine completes any conceivable unitary transaction or activity on behalf of a contact, and then transferring it to contact management facility 1100 to be stored in contact database 1200 associated with the contact for whom the work was done may constitute an activity tracker, and all such activity trackers are included in the spirit and scope of the present invention.

What is claimed is:

1. A distributed GPS-based sales efficiency management system for automatically measuring, accumulating, determining, geographically tracking, and recording: the activities undertaken by at least one selling entity on behalf of at least one contact; the time and expense associated with those activities; and the efficiency of the selling entity's activities prospecting, contacting, buying, and selling on behalf of the contact, wherein:
a. at least one activity tracker automatically collects first information including at least the time expended (or to be expended) in conjunction with at least one activity undertaken by the selling entity on behalf of the contact; and
i. at least one GPS receiver automatically collecting (or predicting) the physical location of the at least one activity;
b. wherein:
i. the system collects second information from the selling entity about the revenue generated (or to be generated) by the selling entity from the contact;
ii. the system collects third information from the selling entity about the expenses incurred (or to be incurred) by the selling entity on behalf of the contact; and
iii. the system calculates at least one sales efficiency ratio based on some combination of revenue, expenses, and net revenue as a function of the first information and physical geography.

2. A system of claim 1 wherein said sales efficiency ratio comprises at least revenue per unit time expended.

3. A system of claim 1 wherein said sales efficiency ratio comprises at least expenses per unit time expended.

4. A system of claim 1 wherein said sales efficiency ratio comprises at least net revenue per unit time expended.

5. A system of claim 1 wherein said sales efficiency ratio comprises at least revenue per other activity.

6. A system of claim 1 wherein said sales efficiency ratio comprises at least expenses per other activity.

7. A system of claim 1 wherein said sales efficiency ratio comprises at least net revenue per other activity.

8. A system of claim 1 wherein said sales efficiency ratio comprises at least revenue per unit distance traveled.

9. A system of claim 1 wherein said sales efficiency ratio comprises at least expenses per unit distance traveled.

10. A system of claim 1 wherein said sales efficiency ratio comprises at least net revenue per unit distance traveled.

11. A real-time distributed GPS-based sales efficiency management device comprising:
a. a processing system;
b. a machine-readable storage system;
c. a network communication system;
d. a database;
e. first machine-readable instructions stored on the storage system and executable on the processing system for receiving and storing at least one first information in the database from at least one activity tracker equipped with at least one GPS receiver;
f. second machine-readable instructions stored on the storage system and executable on the processing system for inputting and storing at least one second information and at least one third information in the database;
g. third machine-readable instructions stored on the storage system and executable on the processing system for retrieving first information, second information, and third information from the database and calculating at least one sales efficiency ratio from particular combinations of them;
h. fourth machine-readable instructions stored on the storage system and executable on the processing system for uploading first information, second information, third information, and at least one calculated sales efficiency ratio to the Internet by means of said network communication system; and
i. fifth machine-readable executable instructions stored on the storage system and executable on the processing system implementing an activity tracker for transmitting, receiving, recording and collecting geography data first information.

12. A distributed GPS-based sales efficiency management device of claim 11 wherein said processing system comprises a single processing unit, said machine-readable storage system comprises single machine-readable storage, and said GPS device comprises single machine-readable GPS device and together they comprise a computing device.

13. A distributed GPS-based sales efficiency management device of claim 12 wherein said computing device is a personal computer.

14. A distributed GPS-based sales efficiency management device of claim 12 wherein said computing device is a tablet computer.

15. A distributed GPS-based sales efficiency management device of claim 12 wherein said computing device is a mobile phone.

16. A distributed GPS-based sales efficiency management device of claim 12 wherein said computing device is an eyeglass device.

17. A distributed GPS-based sales efficiency management device of claim 12 wherein said computing device is a wristwatch device.

18. A distributed GPS-based sales efficiency management device of claim 12 wherein said computing device is a wearable computing device.

19. One or more machine-readable executable instructions implementing a method for performing a distributed GPS-based sales efficiency management device for automatically measuring, accumulating, determining, recording a plurality of activities and geographically tracking the location and distance travelled by a selling entity on behalf of a contact, the method comprising the steps of:
a. inputting, storing, retrieving, and edit in the database contact information relating to at least one contact;
b. receiving and storing in the database at least one first information generated by at least one activity tracker and at least one GPS receiver in connection with an activity performed on behalf of the contact;
c. inputting and storing in the database at least one second information and at least one third information associated with the at least one first information generated by the at least one activity tracker;
d. calculating and storing sales at least one sales efficiency ratio from particular combinations of first information, second information, and third information in real-time;
e. retrieving and displaying first information, second information, third information, and at the at least one sales efficiency ratio in real-time; and
f. retrieving and uploading first information, second information, third information, and the at least one at the at least one sales efficiency ratio to the Internet.
g. reviewing uploaded first information, second information, third information, and at the at least one sales efficiency ratio remotely by means of a web browser coupled to a network such as the Internet.

20. A real-time distributed GPS-based sales efficiency management device comprising:
a. a processing system;
b. a machine-readable storage system;
c. a network communication system;
d. a database;
e. first machine-readable instructions stored on the storage system and executable on the processing system for receiving and storing at least one first information in the database from at least one activity tracker and at least one GPS receiver;
f. second machine-readable instructions stored on the storage system and executable on the processing system for inputting and storing at least one second information and at least one third information in the database;
g. third machine-readable instructions stored on the storage system and executable on the processing system for retrieving first information, second information, and third information from the database and calculating at least one sales efficiency ratio from particular combinations of them;
h. fourth machine-readable instructions stored on the storage system and executable on the processing system for uploading first information, second information, third information, and at least one calculated sales efficiency ratio to the Internet by means of said network communication system; and
i. fifth machine-readable executable instructions stored on the storage system and executable on the processing system implementing an activity tracker for transmitting, receiving, recording and geo-location data first information.

21. A distributed GPS-based sales efficiency management device of claim 20 wherein:
a. said processing system comprises more than one physically dissociated processing unit;
b. said machine-readable storage system comprises more than one physically dissociated machine-readable storage medium;
c. said network communication system comprises more than one physically dissociated network communication device and each of said physically dissociated processing units is coupled to a different one of said physically dissociated machine-readable storage media and a different one of said network communication devices;
d. each of said physically dissociated machine-readable storage media contains sixth machine readable instructions for transferring first information, second information, third information, sales efficiency ratios, and information characterizing electronic transactions between at least two physically dissociated processing units using said their coupled network communication devices.
